(19) United States
(12) Patent Application Publication
(10) Pub. No.: US 2007/0010632 A1
(43) Pub. Date: Jan. 11, 2007

(54) Antioxidant-functionalized polymers

(76) Inventors: David L. Kaplan, Concord, MA (US); Amarjit Singh, Medford, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/536,810

(22) PCT Filed: Nov. 26, 2003
(86) PCT No.: PCT/US03/37775

§ 371 Date: Sep. 19, 2006

Related U.S. Application Data
(60) Provisional application No. 60/429,697, filed on Nov. 27, 2002.

(51) Int. Cl. C08L 63/00

(52) U.S. Cl. 525/423

(57) ABSTRACT

Methods and compositions are disclosed for the preparation of free radical scavenging polymers and polymer films functionalized with antioxidants. Enzymatic and chemical tailoring of monomers with antioxidants followed by enzymatic polymerization is described. These antioxidant functionalized polymers can increase shelf life and quality of food products, as well as, increase effectiveness of pharmaceutical agents when used as packaging or as coatings on packaging for oxygen sensitive materials. The novel enzymatic covalent coupling of antioxidants to a polymer enhances the free radical scavenging ability of packaging while also inhibiting the escape of the antioxidants, and thus limiting exposure and/or absorption by an individual. In addition to its use in food or pharmaceutical packaging, methods are disclosed for using the antioxidant coupled polymers in a variety of applications including as coatings on the inside of medical devices, such as stents and catheters, which would substantially reduce free radical damage and/or oxygen depletion during medical procedures. Furthermore, through the coupling of antioxidants to biodegradable polymers, controlled delivery and sustained release of an antioxidant to a subject is possible.

### FIELD OF THE INVENTION

The technical field of this invention is polymer chemistry and in particular the production and uses of antioxidant-functionalized polymers.

### BACKGROUND OF THE INVENTION

Nearly all foods, beverages, and pharmaceutical agents undergo gradual changes during storage. Ignoring degradation caused by microorganisms, spoiling is typically caused by the presence of oxygen and the products of chemical oxidation. The process of auto-oxidation, which leads to the development of rancidity, flavor and color changes, involves a free radical chain mechanism. In addition, lipids deteriorate due to oxidation, especially at elevated temperatures. Susceptibility to oxidation depends upon the degree of unsaturation. Since almost every product including foodstuff, pharmaceuticals, photochemicals, adhesives, and polymer precursors undergo oxygen degradation, there is a well recognized need for methods and compositions that can counteract the damaging effects of oxygen.

Preservatives with antioxidant activity are commonly added to packaged foods to scavenge the oxygen radicals. However, many preservatives used for food, medicine and other personal care products have been associated with adverse side effects. Therefore, a major concern in the area of human health and well being is the excessive use and exposure to these commonly used synthetic compounds, which may lead to unwanted and detrimental effects. Examples of such adverse effects include allergies to benzoic acid and sulphites, the production of carcinogenic nitrosamines from nitrites, and the carcinogenic effects of butylated hydroxyanisole (BHA) and butylated hydroxytoluene (BHT). Typically these preservatives are used in ways that allow them to be consumed or absorbed through the skin, leading to accumulating amounts of these compounds in human beings. Consequently, a need exists for an oxygen scavenging system that both utilizes natural or organic compounds and/or reduces the absorption of such compounds into the body.

Currently used strategies for protecting foodstuff and the like include coating oxygen sensitive materials with antioxidant compositions, coating the antioxidants themselves with substances that allow for sustained release, and mixing antioxidants with carriers such as polymers. However, existing methods and compositions typically allow the oxygen scavenging material to leach out of its carrier into the oxygen sensitive materials.

Furthermore, many antioxidants are also inherently susceptible to oxygen degradation, which renders them not functional or less potent in their ability to scavenge free radicals over time. Thus, the industry would greatly benefit from a system in which the antioxidant could be immobilized but yet fully functional. Such an improvement could positively affect manufacturing procedures, quality of goods, efficacy of pharmaceuticals, as well as, the safety of certain medical materials and procedures.

Accordingly, there exists a need for new methods and compositions that provide improved oxygen scavenging capabilities.

### SUMMARY OF THE INVENTION

Methods and compositions are disclosed for the preparation of free radical scavenging polymers and polymer films functionalized with antioxidants. Enzymatic and chemical tailoring of monomers to include antioxidants followed by enzymatic polymerization is described. These antioxidant functionalized polymers can increase shelf life and quality of food products, as well as, increase effectiveness of pharmaceutical agents when used as packaging or as coatings on packaging for oxygen sensitive materials. The novel enzymatic covalent coupling of antioxidants to a polymer enhances the free radical scavenging ability of packaging while also inhibiting the escape of the antioxidants, and thus limiting exposure and/or absorption by an individual. In addition to its use in food or pharmaceutical packaging, methods are disclosed for using the antioxidant coupled polymers in a variety of applications including as coatings on the inside of medical devices, such as stents and catheters, which would substantially reduce free radical damage and/or oxygen depletion during medical procedures. Furthermore, through the enzymatic coupling of antioxidants to biodegradable polymers, controlled delivery and sustained release of an antioxidant to a subject is possible.

The present invention is based, in part, on the discovery of a method of coupling of antioxidants to monomers followed by enzymatic polymerization which retains antioxidant function. The functionalized polymer can be readily processed into films, fibers or other shaped forms depending on intended use, behaving like the unmodified polymer in many respects with added antioxidant functionality. The present invention also discloses a method of enzymatically coupling antioxidants to polymers that is a significant improvement over known chemical methods. The reactions are easily scalable so that large quantities can be generated; therefore, the methods are easily adapted to high through-put selective coupling while still allowing control over the degree of substitution. Furthermore, enzymes can be engineered to allow specific coupling tailored to the desired antioxidant and/or monomer.

In one embodiment, the invention makes use of organic coupling procedures and biochemistry methods of enzymology to enzymatically couple antioxidants to polymers and polymerize antioxidant functionalized monomers. Non-limiting examples of antioxidants that can be coupled using the present methods include, but are not limited to, ascorbic acid, vitamin E derivatives, tocol, α-tocopherol, β-tocopherol, γ-tocopherol, φ-tocopherol, ε-tocopherol, ξ1-tocopherol, ξ2-tocopherol, η-tocopherol, vitamin B derivatives, thiamine, cyanocobalamin, ergocalciferol, cholecalciferol, vitamin K derivatives, phytonadione, menaquinone, quercetin, vitamin A derivatives, retinol, retinal, 3,4-didehydroretinol, α-Carotene, β-carotene, δ-carotene, γ-carotene, cryptoxanthin, citric acid, butylated hydroxyanisole, butylated hydroxytoluene, alpha-lipoic acid, glutathione, carotenoids, allylic sulfides, selegiline, N-actylcysteine, lecithin, tartaric acid, caffeic acid, diaryl amines, thioethers, quinones, tannins, xanthenes, procyanidins, porphrins, phenolphthalein, indophenol, coumarins, flavones, flavanones, and isomers derivatives, and combinations thereof. In one embodiment, the resultant functionalized polymer has at least 70% of the monomeric units coupled to antioxidants. Preferably, 90% of the monomeric units are functionalized. More preferably, at least one antioxidant is coupled to each monomer.

A major concern in many areas of human health and well being is the excessive use and exposure to chemical antioxidants. Thus, there is renewed interest in the potential of “natural” and more water soluble antioxidants. In one embodiment, the antioxidants coupled to the monomers are organic compounds, which are not only not harmful, but have beneficial health effects. In addition, the covalent coupling of the antioxidants to non-biodegradable monomers prevents absorption of the monomers by an individual while protecting oxygen sensitive materials from degradation.

In one aspect of the present invention, a method for the enzymatic synthesis of functionalized polymers is disclosed. Following the activation of monomer units, antioxidants can be coupled to the monomers. In one embodiment, the monomers are functionalized with antioxidants using chemical synthesis. In a preferred embodiment, the monomers are enzymatically functionalized with antioxidants through the selective, enzymatic covalent coupling of the antioxidant. The monomers can by enzymatically polymerized following antioxidant tailoring. The choice of monomer and enzyme is relevant to the use and application of the resultant antioxidant functionalized polymer. Non-limiting examples of monomers include, but are not limited to, vinylbenzoic acid, amino acids, amino acid derivatives, carbohydrates, lactones, esters, olefins, amides, urethanes, acrylides, vinyl monomers, vinyl ethers, acetals, aryl sulfones, ether sulfones, inides, etherketones, phenylene oxides, phenylene sulfides, carbonates, epoxides, phenolics, aminoplasts, saphorolactones, nucleosides, and dendrimers. In one embodiment, a lipase is used to catalyze transesterification resulting in covalent attachment of the antioxidant to the monomer through selective acylation of the primary hydroxyl group of the antioxidant. In another embodiment, horseradish peroxidase (HRP) is used to catalyze the polymerization of functionalized monomers.

In one embodiment, vinyl polymers are formed with pendent antioxidant functional groups. In a preferred embodiment, vinyl monomers can be selectively enzymatically coupled to the primary hydroxyl group of ascorbic acid. The ascorbyl coupled polymer with inherent antioxidant activity can have the core structure shown below: 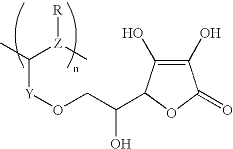
wherein Y is absent, C₂H₂O, C₇H₄O or a linking group; Z is selected from the group consisting of O, S, N, C, CH, C₆H₃, C₆H₄, CₐH_{b}, C₆H₁₀O₂, and CₐH_{b}Oₘ, wherein a, b, and m are integers; R is selected from the group consisting of absent, hydrogen, oxygen, an alkyl, a hydroxy, an aryl, an aliphatic group, an aromatic group, an acyl group, an alkoxy group, an alkylene group, an alkenylene group, an alkynylene group, a hydroxycarbonylalkyl group, an anhydride, a halide, an amide, an amine, and a heterocyclic aromatic group; and n is an integer greater than or equal to one denoting the degree of polymerization.

In this embodiment, the enzymatic coupling methods of the present invention are based on the use of mild and highly selective enzymes to covalently attach an antioxidant compound, which retains its activity, to a vinyl polymer. The enzymatic strategy is a significant improvement over chemical approaches. Chemical coupling of the antioxidant to the polymer is extremely difficult, results in the mixture of products, requires many more steps leading to much lower yields than the enzymatic method described in the present invention. Enzymatic coupling allows selective coupling to the hydroxyl group of interest without the need for protecting groups.

In one embodiment, the enzyme Candida antarctica lipase can be used to specifically couple the primary hydroxyl group of ascorbic acid to an activated monomer. This hydroxyl group has been implicated in the initial steps of ascorbic acid degradation. Therefore, stabilizing this reactive hydroxyl group can reduce the susceptibility of ascorbic acid to oxygen degradation leading to added stability and improved effectiveness.

In one aspect, the present invention can be used to protect oxygen sensitive material from degradation. Coupling of the antioxidant to a polymer, and thus preventing absorption and/or exposure of these compounds by a person is an improvement over antioxidant mixtures or emulsions which are added directly to food or pharmaceutical agent. In one embodiment, the present invention can be used as a packaging for foods and beverages such that any oxygen leading to free radicals will be scavenged right at the packaging surface, thus avoiding the need to add bulk antioxidants into the product. The antioxidant-coupled polymer can be cast into a film, fiber, coating, sheet, and combinations thereof. In another embodiment, a second oxygen impermeable packaging material can be applied over the antioxidant-coupled polymer adding further protection to the sensitive material. The present invention can be used to protect food or pharmaceutical agents while not changing the flavor, odor, color, efficacy, or organoleptic properties.

In another embodiment, the present invention can be used as a medical device in which at least one surface which is in direct contact with oxygen sensitive material is coated with antioxidant functionalized polymers so as to protect oxygen sensitive material from degradation. The medical device can be an implantable medical device selected from the group consisting of dialysis apparatus, stents, filtration apparatus, catheters, sutures, tubings, syringes, endoscopes, and prostheses. In another embodiment, the medical device is coated with antioxidant coupled biodegradable polymers such that the antioxidant is slowly released upon degradation and can be absorbed by the subject.

In another aspect, the present invention describes a method of controlled delivery of an antioxidant to a subject involving coupling of antioxidants to each of a plurality of biodegradable monomers which are then enzymatically polymerized. In one embodiment, the antioxidants are enzymatically coupled to a plurality of biodegradable monomers. The resultant antioxidant coupled polymer will degrade over time and deliver the antioxidant at a controlled rate. Antioxidants are important in reducing the impact of aging-related phenomena in humans, thus high contents of vitamin C and other natural antioxidants are used by many consumers. The antioxidant coupled biodegradable polymers may be designed so that release of the antioxidant from the polymer is controlled and scalable based upon need. In one embodiment, the functionalized biodegradable polymer is implantable. In another embodiment, it is ingestable. In yet another embodiment, it can be applied topically, as an ointment, cosmetic, or other personal care product. This embodiment may be particularly useful to prevent aging effects on the skin. The biodegradable monomers can be selected from, but not limited to, the group consisting of polyesters, glycolides, lactides, trimethylene carbonates, caprolactones, dioxanone, hydroxybutyrates, hydroxyvalerates, carbonates, amino acids, “pseudo” amino acids, esteramides, anhydrides, orthoesters, saphorolactones, nucleosides, biodegradable dendrimers, and combinations thereof. The method comprises coupling at least 1% of the activated monomers with antioxidants, preferably at least 10%, more preferably at least 50%. More preferable at least one antioxidant is coupled per monomer. In another embodiment, a controlled delivery system for antioxidants comprises an antioxidant bound to a biodegradable polymer, wherein the antioxidant is present in an amount from about 20% to about 80% (w/w).

The present invention has many benefits over known methods of antioxidant scavenging techniques. Antioxidants specifically coupled to monomer units ensure broad and effective dispersion of the antioxidant while eliminating the particle dispersion problem of emulsions or mixtures. Since the antioxidants do not leach out of the polymer matrix, the compositions are non-staining, non-discoloring, non-toxic, odorless and tasteless. Immobilizing the antioxidant also improves its long term stability. In addition, the present invention is compatible with use of other antioxidants, preservatives and stabilizers and may provide a simple solution to recycling of certain compounds. For example, the maintenance of vitamin E in its non-radical reduced form is dependent upon the vitamin C. Therefore, if vitamin C or vitamin E is coupled to the polymer and the other is added to oxygen sensitive material, the potency and effectiveness of antioxidant protection would be greatly improved. This novel method of enzymatically polymerizing antioxidant-coupled monomers to functionalized polymers is highly specific and adaptable to high-through put manufacturing. In addition, enzymatically coupling the antioxidants to biodegradable polymers, allows a variety of medicinal uses including a controlled delivery system for antioxidants used in treatment and/or prevention of diseases.

### BRIEF DESCRIPTION OF THE DRAWINGS

FIG. 1 is a schematic illustration of the enzymatic coupling of ascorbic acid to p-vinylbenzoic acid and enzymatic polymerization to form a polymerized L-ascorbyl 4-vinylbenzoate (4);

FIG. 2 is a ¹H NMR spectrum of polymerized L-ascorbyl 4-vinylbenzoate (4);

FIG. 3 is a MALDI-TOF spectrum of polymerized L-ascorbyl 4-vinylbenzoate (4);

FIG. 4 is a schematic illustration of the enzymatic coupling of ascorbic acid to p-hydroxyphenyl acetic acid followed by enzymatic polymerization to form polymerized L-ascorbyl 4-hydroxyphenyl acetate (8);

FIG. 5 is a schematic illustration of the coupling of retinol to p-vinylbenzoic acid followed by enzymatic polymerization to form polymerized retinyl 4-vinylbenzoate (11);

FIG. 6 is a schematic illustration of the coupling of retinol to p-hydroxyphenyl acetic acid followed by enzymatic polymerization to form polymerized retinyl 4-hydroxybenzylacetate (15); and

FIG. 7 is a schematic illustration of the coupling of tocol to p-vinylbenzoic acid followed by enzymatic polymerization to form polymerized 2-methyl-2-(4,8,12-trimethyltridecyl)-6-(4-vinylbenzoyl)-chromanol (20);

FIG. 8 is a schematic illustration of the lipase catalyzed ring opening polymerization of caprolactone using the primary hydroxyl group of ascorbic acid as the initiator;

FIG. 9 is a schematic illustration of the enzymatic coupling of L-ascorbic acid to 2,2,2-trifluoroethyl methacrylate followed by enzymatic polymerization to form polymerized L-ascorbyl methylmethacrylate (23);

FIG. 10 is an ¹H NMR spectrum of polymerized L-ascorbyl methylmethacrylate (23);

FIG. 11 is a schematic illustration of an embodiment of the present invention in which the amino group of 6-deoxyamino L-ascorbate (27) is used for lipase catalyzed ring opening polymerization;

FIG. 12 is schematic illustration of an embodiment of the present invention in which the amino acid functionalized ascorbic acid is used for lipase catalyzed ring opening polymerization; and

FIG. 13 is schematic illustration of an embodiment of the present invention in which lipase-catalyzed ring opening polymerization of lactones is carried out using lipases to produce ascorbic acid functionalized polymers.

### DETAILED DESCRIPTION OF THE INVENTION

The present invention provides methods and compositions for coupling antioxidants to monomers and polymerizing the functionalized monomers. Methods of selective enzymatic covalent coupling are disclosed. The invention provides a method for packaging foodstuff and pharmaceuticals that protects from oxidative degradation. The methods and compositions of the invention can be used to prevent or slow degradation of oxygen sensitive materials. Use of the invention to coat biomedical devices that transport oxygen sensitive materials is also disclosed. In addition, a method for administering a sustained and controlled amount of the antioxidant to a subject following the predicted degradation of a biodegradable polymer is described. The practice of the present invention employs, unless otherwise indicated, conventional methods of organic chemistry, biochemistry, and polymer chemistry.

So that the invention is more clearly understood, the following terms are defined:

The term “antioxidant” as used herein refers to a substance that, when present in a mixture or structure containing an oxidizable substrate molecule (e.g., an oxidizable biological molecule or oxidizable indicator), significantly delays or prevents oxidation of the oxidizable substrate molecule. Antioxidants can act by scavenging biologically important reactive free radicals or other reactive oxygen species (e.g., O₂⁻, H₂O₂, HOCl, ferryl, peroxyl, peroxynitrite, and alkoxyl), or by preventing their formation, or by catalytically converting the free radical or other reactive oxygen species to a less reactive species. Antioxidants can be used to prevent food spoilage and to prevent or slow degradation or reduction in the effectiveness of pharmaceutical agents. Antioxidants can be separated into two classes, lipid antioxidants, and aqueous antioxidants. Examples of lipid antioxidants include, but are not limited to, carotenoids (e.g. lutein, zeaxanthin, β-cryptoxanthin, lycopene, α-carotene, and β-carotene), which are located in the core lipid compartment, and tocopherols (e.g. vitamin E, tocol, α-tocopherol, γ-tocopherol, and δ-tocopherol), which are located in the interface of the lipid compartment, and retinoids (e.g. vitamin A, retinol, and retinyl palmitate) and fat-soluble polyphenols such as quercetin. Examples of aqueous antioxidants include, but are not limited to, ascorbic acid and its oxidized form, “dehydroascorbic acid”, uric acid and its oxidized form, “allantoin”, bilirubin, albumin and vitamin C and water-soluble polyphenols such as catechins, which have high affinity to the phospholipid membranes, isoflavones, and procyanidins.

When one more antioxidants are added to a test sample or assay, a detectable decrease in the amount of a free radical, such as superoxide, or a nonradical reactive oxygen species, such as hydrogen peroxide, may be seen in the sample, compared with a sample untreated with the antioxidant (i.e. control sample) or assay reaction. Electron spin resonance (ESR) can be used to measure free radicals directly. However, numerous indirect methods exist such as monitoring the change in antioxidant status, assays that trap hydroxyl radicals, and monitoring degradation products caused by free radicals (i.e. lipid peroxidation). Suitable concentrations of antioxidants measured to produce the desired change or amelioration, (e.g., an efficacious or therapeutic dose) can be determined by various methods, including generating an empirical dose-response curve.

The term “free radical” as used herein refers to molecules containing at least one unpaired electron. Most molecules contain even numbers of electrons, and their covalent bonds normally consist of shared electron pairs. Cleavage of such bonds produces two separate free radicals, each with an unpaired electron (in addition to any paired electrons). They may be electrically charged or neutral and are highly reactive and usually short-lived. They combine with one another or with atoms that have unpaired electrons. In reactions with intact molecules, they abstract a part to complete their own electronic structure, generating new radicals, which go on to react with other molecules. Such chain reactions are particularly important in decomposition of substances at high temperatures. In the body, oxidized (see oxidation-reduction) free radicals can damage tissues. Antioxidant nutrients (e.g., vitamins C and E, selenium, polyphenols) may reduce these effects. Heat, ultraviolet light, and ionizing radiation all generate free radicals. Free radicals are generated as a secondary effect of oxidative metabolism. An excess of free radicals can overwhelm the natural protective enzymes such as superoxide dismutase, catalase, and peroxidase. Free radicals such as hydrogen peroxide (H₂O₂), hydroxyl radical (HO●), singlet oxygen (¹O₂), superoxide anion radical (O●₂⁻), nitric oxide radical (NO●), peroxyl radical (ROO●), peroxynitrite (ONOO⁻) can be in either the lipid or aqueous compartments.

The term “polymer” as used herein refers to a large molecule built up by the repetition of small, simple chemical units, monomers, formed in an association reaction in which many molecules come together to form one large molecule. The length of the polymer chain is specified by the number of repeat units in the chain. The resulting polymer can have more than one type of repeating monomer.

The term “copolymer” as used herein refers to a polymer made from two (or more) different monomer building blocks., such as styrene-butadiene rubber (SBR).

The term “monomer” as used herein refers to a starting material from which a polymer is formed and encompasses homogenous and heterogeneous combinations thereof. The starting units may be selected from, but not limited to, the group consisting of vinylbenzoic acid, amino acids, amino acid derivatives, carbohydrates, lactones, lactides, cyclic carbonates, esters, olefins, amides, urethanes, acrylides, vinyl monomers, vinyl ethers, acetals, aryl sulfones, ether sulfones, imides, etherketones, phenylene oxides, phenylene sulfides, carbonates, epoxides, phenolics, aminoplasts, saphorolactones, nucleosides, and dendrimers and combinations thereof. The term “monomer” is also intended to include biodegradable monomers including, but not limited to, polyesters, glycolides, lactides, trimethylene carbonates, caprolactones, dioxanone, hydroxybutyrates, hydroxyvalerates, carbonates, amino acids, “pseudo” amino acids, esteramides, anhydrides, orthoesters, saphorolactones, nucleosides, and biodegradable dendrimers and combinations thereof.

The term “linking group,” as used herein, refers to any moiety capable of joining two atoms, e.g., the adjacent carbon and oxygen. The term linking group is intended to include, but not limited to, carbon (C), oxygen (O), sulfur (S), nitrogen (N), CH, C₆H₃, C₆H₄, CₐH_{b}, C₆H₁₀O₂, C₂H₂O, C₇H₄O, and CₐH_{b}Oₘ, wherein a, b, and m are integers. The linking group can also be selected from the group consisting of an alkyl, a hydroxy, an aryl, an aliphatic group, an aromatic group, an acyl group, an alkoxy group, an alkylene group, an alkenylene group, an alkynylene group, a hydroxycarbonylalkyl group, an anhydride, an amide, an amine, and a heterocyclic aromatic group, vinylbenzoic acid, amino acids, amino acid derivatives, carbohydrates, lactones, lactides, cyclic carbonates, esters, olefins, amides, urethanes, acrylides, vinyl monomers, vinyl ethers, acetals, aryl sulfones, ether sulfones, imides, etherketones, phenylene oxides, phenylene sulfides, carbonates, epoxides, phenolics, aminoplasts, saphorolactones, nucleosides, dendrimers, polyesters, glycolides, lactides, trimethylene carbonates, caprolactones, dioxanone, hydroxybutyrates, hydroxyvalerates, carbonates, “pseudo” amino acids, esteramides, orthoesters, saphorolactones, nucleosides, biodegradable dendrimers, and segments and combinations thereof. The linking group can be a biodegradable moiety. The linking group can also be absent resulting in the direct bonding of the carbon and oxygen.

The term “oxygen impermeable” as used herein refers to the inability of at least 50% of oxygen molecules to freely pass through such material.

The term “subject” as used herein refers to any living organism in which an immune response is elicited. The term “subject” includes, but is not limited to, humans, nonhuman primates such as chimpanzees and other apes and monkey species; farm animals such as cattle, sheep, pigs, goats and horses; domestic mammals such as dogs and cats; laboratory animals including rodents such as mice, rats and guinea pigs, and the like. The term does not denote a particular age or sex. Thus, adult and newborn subjects, as well as fetuses, whether male or female, are intended to be covered.

The phrase “free radical associated disorder” as used herein refers to a pathological condition of in a subject that results at least in part from the production of or exposure to free radicals, for example, oxyradicals, or other reactive oxygen species in vivo. The term “free radical associated disorder” encompasses pathological states that are recognized in the art as being conditions wherein damage from free radicals is believed to contribute to the pathology of the disease state, or wherein administration of a free radical inhibitor (e.g., desferrioxamine), scavenger (e.g., tocopherol, glutathione), or catalyst (e.g., SOD, catalase) is shown to produce a detectable benefit by decreasing symptoms, increasing survival, or providing other detectable clinical benefits in protecting or preventing the pathological state. Examples of free radical disorders include, but are not limited to, ischemic reperfusion injury, inflammatory diseases, systemic lupus erythematosis, myocardial infarction, stroke, traumatic hemorrhage, spinal cord trauma, Crohn's disease, autoimmune diseases (e.g., rheumatoid arthritis, diabetes), cataract formation, age-related macular degeneration, Alzheimer's disease, uveitis, emphysema, gastric ulcers, oxygen toxicity, neoplasia, undesired cell apoptosis, and radiation sickness. Such diseases can include “apoptosis-related ROS” which refers to reactive oxygen species (e.g., O₂⁻) which damage critical cellular components (e.g., lipid peroxidation) in cells stimulated to undergo apoptosis, such apoptosis-related ROS may be formed in a cell in response to an apoptotic stimulus and/or produced by non-respiratory electron transport chains (i.e., other than ROS produced by oxidative phosphorylation).

The term “oxidative stress” as used herein refers to the level of damage produced by oxygen free radicals in a subject. The level of damage depends on how fast reactive oxygen species are created and then inactivated by antioxidants.

The term “nutraceutical” as used herein refers to an isolated or purified compound or composition generally sold in medicinal forms that have a demonstrated physiological benefit or provide protection against chronic disease. Non-limiting examples of neutraceuticals include soy protein, calcium, vitamin E, isoflavones, and beta-carotene. Functionalized biodegradale polymers would have neutraceutical application, since the dosage can be controlled and sustained over time.

The invention is described in more detail in the following subsections:

I. Antioxidants

A. General

Free radicals are very unstable and react quickly with other compounds beginning a muti-step chain reaction. Free radicals arise normally during metabolism or may result from environmental factors such as pollution, radiation, cigarette smoke, and herbicides. Antioxidants act as scavengers, helping to prevent cell and tissue damage that could lead to cellular damage and disease. While some antioxidants are produced in the body, others come from food. For example, after vitamin E neutralizes a harmful radical it can be recycled back to its original form by interacting with vitamin C. Vitamin C is recycled by interacting with another antioxidant such as glutathione. Antioxidants useful for the present invention may be selected from, but not limited to, the group consisting of ascorbic acids, vitamin E derivatives, tocols, α-tocopherols, β-tocopherols, γ-tocopherols, φ-tocopherols, ε-tocopherols, ξ1-tocopherols, ξ2-tocopherols, η-tocopherols, vitamin B derivatives, thiamines, cyanocobalamins, ergocalciferols, cholecalciferols, vitamin K derivatives, phytonadiones, menaquinones, quercetins, vitamin A derivatives, retinols, retinals, 3,4-didehydroretinols, α-carotenes, β-carotenes, δ-carotenes, γ-carotenes, cryptoxanthins, citric acid, butylated hydroxyanisoles, butylated hydroxytoluenes, alpha-lipoic acids, glutathiones, carotenoids, allylic sulfides, selegilines, N-actylcysteines, lecithins, tartaric acids, caffeic acids, diaryl amines, thioethers, quinones, tannins, xanthenes, procyanidins, porphrins, phenolphthaleins, indophenol, coumarins, flavones, flavanones, and isomers, derivatives, and combinations thereof. Examples 2, 5, and 6 demonstrate that the present methods can be used with a variety of antioxidants, such as ascorbic acid, tocol, and retinol.

B. Ascorbic Acid

Ascorbic acid (C₆H₈O₆), otherwise known as vitamin C or the γ-lactone L-3-ketothreohexuronic acid, is essential to the human diet, since primates and guinea pigs are the only animals unable to produce this essential vitamin. Ascorbic acid is a water-soluble, chain-breaking antioxidant which reacts directly with singlet oxygen, hydroxyl, and superoxide radicals. It also may react with tocopheroxy radicals to regenerate vitamin E. It is an important part of the synthesis of collagen and carnitine, and is the human body's primary water-soluble antioxidant. Ascorbic acid has been associated with the treatment of many disorders including the common cold and cancer through stimulation of the immune system and protecting the body against free radicals. Vitamin C is very important in the healing of wounds and broken bones. It also aids in the production of hemoglobin and red blood cells in the bone marrow. Large doses of vitamin C, taken every day has been show to reduce asthma symptoms, as well as to lower the risk of glaucoma, cataracts, or cardiovascular disease. Ascorbic acid is used by the adrenal gland to make hormones such as adrenaline, and hormones that regulate blood sugar and blood minerals. It can also be found in large quantities in the brain as it plays an important role in nerve transmission by changing amino acids into neurotransmitters. Ascorbic acid accelerates hydroxylation reactions, in part by donating electrons to metal ion cofactors of hydroxylase enzymes. Hydroxylation reactions are important in collagen synthesis, conversion of lysine to carnitine, conversion of dopamine to norepinephrine, and in tyrosine metabolism. Through its role in collagen synthesis, ascorbic acid strengthens bones, joints, teeth, gums, artery walls, and all connective tissue in the body. It also catalyzes other enzymatic reactions, such as amidation necessary for maximum activity of the hormones oxytocin, vasopressin, cholecystokinin, and alpha-melanotropin (Arrigoni et al. Biochim. Biophys. Acta. 1569: 1-9 (2002)). Deficiency of Vitamin C may lead to soft or bleeding gums, swollen or painful joints, slow-healing wounds and fractures, bruising, nosebleeds, tooth decay, loss of appetite, muscular weakness, skin hemorrhages, capillary weakness, anemia, and impaired digestion.

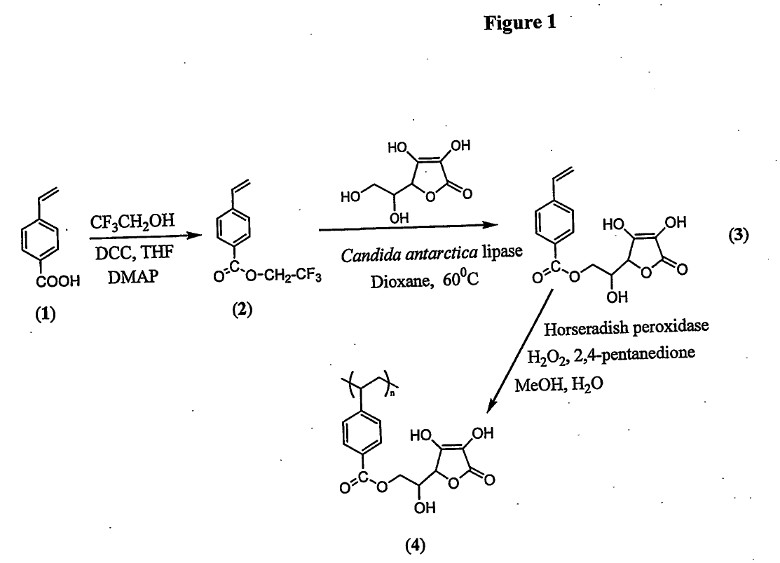

Under physiological conditions, ascorbic acid gets reversibly oxidized to form dehydroascorbic acid which is then followed by the irreversible hydrolysis of the lactone ring to form the inactive diketogulonic acid. In addition, free ascorbic acid undergoes moisture induced degradation which leads to discoloration and inactivation. As many as eight different compounds were found to be present in the degraded product (Shephard, A. B. et al. Talanta 48:585-593 (1999); Shephard A. B. et al. Talanta 48: 595-606 (1999); Shephard, A. B. et al. Talanta 48: 607-622 (1999)). The possible chemical pathway which results in major degradation products involves the primary hydroxyl group of ascorbic acid. The present invention blocks this step of ascorbic acid degradation. The protocol described in Example 2 describes how the primary hydroxyl group is regioselectively protected via mild enzyme catalyzed transesterification reaction which stops degradation as the active ascorbic acid is covalently attached to the vinyl monomer (FIG. 1). The ascorbyl coupled polymer with inherent antioxidant activity can have the core structure shown below: 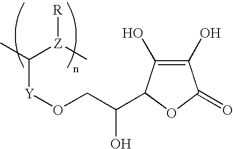
wherein Y is absent, C₂H₂O, C₇H₄O or a linking group; Z is selected from the group consisting of O, S, N, C, CH, C₆H₃, C₆H₄, CₐH_{b}, C₆H₁₀O₂, and CₐH_{b}Oₘ, wherein a, b, and m are integers; R is selected from the group consisting of absent, hydrogen, oxygen, an alkyl, a hydroxy, an aryl, an aliphatic group, an aromatic group, an acyl group, an alkoxy group, an alkylene group, an alkenylene group, an alkynylene group, a hydroxycarbonylalkyl group, an anhydride, a halide, an amide, an amine, and a heterocyclic aromatic group; and n is an integer greater than or equal to one denoting the degree of polymerization. Examples 3 and 5 describe the polymerization of ascorbyl coupled monomers. The resultant ascorbyl coupled polymer retains antioxidant activity as shown in Example 4. In one aspect, the ascorbyl coupled polymer of the present invention could be used to protect oxygen sensitive material from degradation.

The present invention provides methods and compositions that stabilize and inhibit oxidation of ascorbic acid by hindering one of the initial steps in ascorbic acid degradation. Ascorbic acid is highly sensitive to environmental factors such as light, oxygen, and water which lead to its degradation. L-Ascorbic acid is approved for use as a dietary supplement and chemical preservative by the U.S. Food and Drug Administration and is on the FDA's list of substances generally recognized as safe. L-Ascorbic acid has been used in soft drinks as an antioxidant for flavor ingredients, in meat and meat-containing products, for curing and pickling, in flour to improve baking quality, in beer as a stabilizer, in fats and oils as an antioxidant, and in a wide variety of foods for vitamin C enrichment. It is one of the major antioxidant nutrients and has been shown to prevent the conversion of nitrates, such as from tobacco smoke, smog, bacon, lunch meats, and some vegetables, into cancer-causing substances. In one aspect of the invention, the ascorbic acid coupled polymer can be used to stabilize nitrates. In one embodiment, the functionalized polymer could be incorporated into the packaging of food stuff such as bacon, lunch meats, and vegetables. In another embodiment, the ascorbic acid coupled polymer can be used to coat the inside of a bag, carton, box, container, jar or lid of any foodstuff containing package. In yet another embodiment, the functionalized polymer can be coated with a second oxygen impermeable coating. This would be useful for air-tight packaging or vacuum sealed packaging of any oxygen sensitive material. In another embodiment, the ascorbic coupled polymer can be incorporated into cigarette or cigar filters. In yet another embodiment, the present invention may be used as a medical device in which at least one surface, which is in direct contact with oxygen sensitive material, is coated with ascorbyl coupled polymers so as to protect oxygen sensitive material from degradation. The medical device may be an implantable medical device selected from the group consisting of dialysis apparatus, stents, filtration apparatus, catheters, sutures, tubings, syringes, endoscopes, and prostheses. In another embodiment, the medical device is coated with antioxidant coupled biodegradable polymers such that the antioxidant is slowly released upon degradation and can be absorbed by the subject.

L-Ascorbic acid has been used in stain removers, hair waving preparations; plastics manufacture, photography, and water treatment. In another embodiment, the ascorbic coupled polymer could be used in these applications of L-ascobic acid, since the immobilized ascorbic acid may be more stable and thus be more useful than the free antioxidant. In addition, better contol over placement and release would be attainable in a polymer functionalized with ascorbic acid.

In one embodiment, ascorbic acid coupled polymers can be used to provide protection to oxygen sensitive ingestible materials such as foodstuff, pharmaceutical agents, biological fluids or tissues, without increasing levels of vitamin C in the body. The antioxidant is covalently coupled to the polymer preventing leaching out of the polymer and thus it will not be absorbed by the body. While ascorbic acid is usually non-toxic, at high doses (more than 2,000 mg daily) it can cause diarrhea, gas, or stomach upset. In addition, infants born to mothers ingesting 6,000 mg or more of vitamin C may develop rebound scurvy due to sudden drop in daily intake. Furthermore, vitamin C may interact with other drugs. Although vitamin C may protect the stomach and intestines from injury caused by aspirin and nonsteroidal anti-inflammatory drugs (NSAIDs), at high doses of vitamin C (equal to or greater than 500 mg per day) the blood levels of aspirin and other acidic medications may increase. Vitamin C may decrease excretion of acetaminophen in the urine, which may increase blood levels of this medication. Vitamin C may also affect the blood levels of many drugs including diurectics, such as furosemide, beta-blockers, such as propranolol, antiobiotics, such as tetracycline, as well as estradiol, an ingredient in some birth control medications and hormone replacement therapies. Since many people who are taking such medication need to accurately control the levels of ascorbic acid ingested, the present invention can be an extremely important for the effectiveness of their treatment. Currently, ingestible antioxidants are readily added to many foodstuff to provide oxygen scavenging protection. However, with the use of the present compositions and methods, these patients will no longer be at risk.

The combination of vitamin C with nitroglycerin and nitrate medications (isosorbide dinitrate and isosorbide mononitrate), used to treat heart disease, reduces the occurrence of nitrate tolerance, an effect by which the body becomes accustomed to the medicine and then requires a period without the medication in order for it to achieve the desired medicinal effect. Vitamin C reduces nitrate tolerance which may translate into greater effectiveness of the nitrate medication (Daniel, T. A. et al. Ann. Pharmacother. 34 (10): 1193-1197 (2000)).

C. Tocol

Vitamin E, the major lipid soluble chain-breaking in vivo antioxidant, has been show to have a critical role in disease prevention. Vitamin E exerts its role as an antioxidant by quenching free radicals and preventing structural damage to cells, tissues, organelles and lipids that constitute the membrane by-layer. The generic term, vitamin E, comprises all tocol entities exhibiting the biological activity of d-α-tocopherol. Vitamin E has been associated with immunocompetence, inhibition of mutation formation, repair of membranes and cellular structures to include DNA and glycoproteins. Vitamin E has also been shown to reduce, treat, or modulate a variety of disease states or disorders, such as cancer, chronic inflammation, cardiovascular disease, onset of cataracts, the aging process, and diabetic neuropathy (Fairfield K M et al. JAMA 287(23):3116-26 (2002); Sytze Van Dam P. Diabetes Metab Res Rev 18(3):176-84 (2002); Brigelius-Flohe R et al. Am J Clin Nutr 76(4):703-16 (2002)). In addition, vitamin E has been shown to play a role in neurodegenerative disorders, Alzheimer's disease (AD), Parkinson's disease (PD), amyotrophic lateral sclerosis (ALS), tardive dyskinesia, Huntington's disease (HD), and multiple sclerosis, that are associated with oxidative stress resulting from lipid peroxidation (Butterfield D A et al. Nutr Neurosci 5(4):229-39 (2002)). Vitamin E also has been to shown to have effects that are unrelated to antioxidant activity, such as inhibition of cell proliferation, platelet aggregation and monocyte adhesion, which may result from the interaction of vitamin E with cell components (Ricciarelli R et al. Biol Chem 383(3-4):457-65 (2002)).

Eight compounds that exhibit α-tocopherol activity have been found in nature: d-α, d-β, d-δ-, d-γ-tocopherols and the tocotrienols (d-α, d-β, d-δ, d-γ). These compounds differ in the number and position of the methyl groups on the chroman ring. The distribution of the tocopherols varies widely. For example, crude corn and wheat oils may contain as much as 200 mg tocopherols per 100 g, while coconut oil contains very little. α-Tocopherol predominates in safflower oil, γ- and δ-tocopherols are more abundant than α- in soybean, γ- is the prevalent form in corn oil. β-Tocopherol is abundant in wheat germ oil, and is generally found only in traces in other vegetable oils. Tocopherols are extracted commercially from vegetable oilseeds, such as soybean (Bonvehi J S et al. J AOAC Int 83(3):627-34 (2000)).

Natural vitamin E exists as a single molecular structure (RRR- or d-α-tocopherol) derived from vegetable oils, primarily soybean, sunflower, and corn oils. Synthetic vitamin E can be produced commercially by coupling trimethylhydroquinone (TMHQ) with isophytol. The resulting mixture yields eight different compounds, one of which is d-α-tocopherol. The other seven stereoisomers have different molecular structures and reduced biological activity compared to natural vitamin E. Both the natural and synthetic forms of vitamin E are available commercially, primarily as their acetate esters.

D. Retinol

Vitamin A (retinol) is a fat soluble antioxidant. Vitamin A maintains the skin and mucous membranes, promotes growth, strong bones, healthy skin, hair, teeth and gums, builds up resistance to respiratory infections and shortens the duration of diseases. It also counteracts night blindness, reduces many eye disorders and may reduce cancer. In addition, vitamin A is important for reproduction, growth, and immune function. Topical retinol delivery has demonstrated significant anti-inflammatory effects (Wolf J E Jr. Adv Ther 19(3):109-18 (2002)). The best natural sources of vitamin A are green leafy vegetable tops, carrots, red peppers, sweet potatoes, yellow fruits, apricots, fish-liver oil and eggs. Pro-vitamin A carotenoids can also be an important source of the nutrient (Ribaya-Mercado J D Nutr Rev 60(4):104-10 (2002)). The RDA (Recommend Dietary Allowance) for adults is 1000 micrograms RE (Retinol Equivalents. 1 RE=1 microgram retinol or 6 micrograms β-carotene). Excessive amounts of vitamin A, e.g., 100,000 IU/day, can produce severe toxicity.

H. Coupling Antioxidants to Polymers

A. Monomers

The choice of monomers is dependent upon the intended use of the resultant antioxidant coupled polymer. Examples 2, 5, and 6 demonstrate that the present methods of enzymatic coupling of an antioxidant can be used with a variety of monomers. Monomers may be selected from, but not limited to, the group consisting of vinylbenzoic acid, amino acids, amino acid derivatives, carbohydrates, lactones, lactides, cyclic carbonates, esters, olefins, amides, urethanes, acrylides, vinyl monomers, vinyl ethers, acetals, aryl sulfones, ether sulfones, imides, etherketones, phenylene oxides, phenylene sulfides, carbonates, epoxides, phenolics, aminoplasts, saphorolactones, nucleosides, and dendrimers. In addition, monomers may be biodegradable (See below).

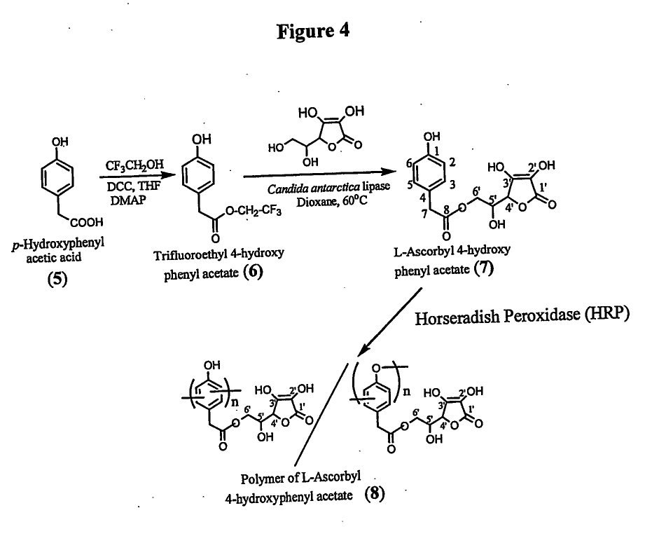

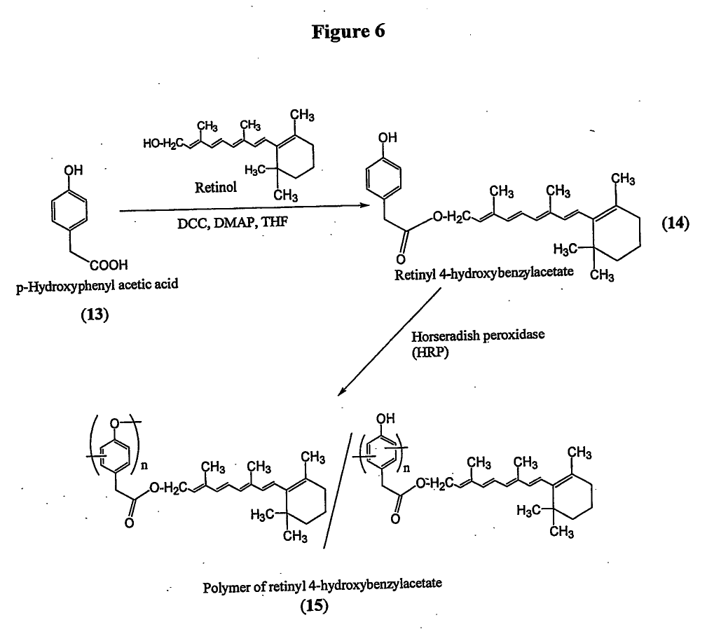

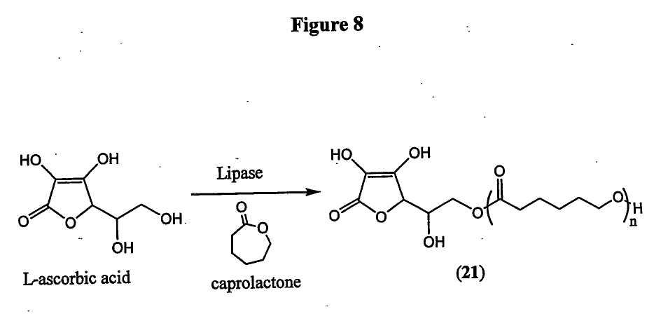

In one embodiment, the monomer is a vinyl monomer as illustrated in FIGS. 1, 5, 7, and 9 and described in Examples 2, 3, 6. In another embodiment, the monomer is a phenolic monomer as illustrated in FIGS. 4 and 6 and described in Examples 5 and 6. In yet another embodiment, the monomer is a lactone as demonstrated in FIG. 8. The monomers can also be cyclic, e.g., lactones, lactides, cyclic carbonates. As demonstrated in FIG. 8, the primary hydroxyl group of ascorbic acid can be used as an initiator in the lipase catalyzed ring opening polymerization (21) of cyclic monomers e.g., caprolactone.

B. Enzymatic Coupling Antioxidants to Monomers

Enzymatic coupling of the antioxidant of choice to the monomer involves the use of an appropriate enzyme. Non-limiting examples of enzymes include proteases, which could be used to form amide linkages between the monomer and the antioxidant, glycosidases, which could be used to form glycosidic linkages between the monomer and antioxidant, and lipases. Lipases or triglycerol ester hydrolases are enzymes which catalyze the hydrolysis of fatty acid esters. Although they usually are found in aqueous environments in living systems, some lipases are stable in organic solvents. Lipases are commonly used enzymes for the catalysis of chemospecific, regiospecific, and/or stereospecific hydrolysis of carboxylic acids esters. Schemes 1 and 2 show the lipase catalyzed esterification (1) and transesterification (2), two reactions which can be used to couple the hydroxyl group of an antioxidant to a monomer.
RCO₂H+R′OH→RCO₂R′+H₂O (1)
RCO₂R′+R″OH→RCO₂R″+R′₂O (2)

Using vinyl acetate as an acylating agent makes the reaction irreversible. Acetaldehyde can deactivate some lipases; however, immobilizing the lipase stabilizes the enzyme (Reetz, M. T. Cur. Opin. Chem. Biol. 6:145-150 (2002)). Candida antarctica lipase, for example, is a well characterized, efficient enzyme that can be immobilized. Example 2 describes the use of Candida antarctica lipase to catalyze transesterfication resulting in the covalently attachment of the antioxidant, ascorbic acid, to a monomer, vinyl benzoate. The enzyme is used to couple an ascorbic acid moiety to at least 1% of the monomers, preferably at least 10%, more preferably at least 50% of the monomers. More preferably, at least one ascorbic acid moiety is attached to each monomer. Immobilization of the enzyme is highly adaptable to industrial applications. In addition, genetic engineering and directed evolution methods can be used to specifically design an enzyme useful for the covalent attachment of the antioxidant of choice (Rotticci, D. et al. ChemBioChem 2: 766-770 (2001)).

C. Enzymatic Polymerization

Polymerization of the functionalized monomers can be done via enzymatic methods. The use of enzymes in chemical polymer synthesis has many advantages including high efficiency of the reactions without the need for harsh reaction conditions (i.e. extreme temperatures, pressure or pH) and the ability to be enantiospecific, regiospecific, chemospecific, as well as, stereospecific. A recent review of enzymatic polymerization (Kobayashi, S. et al. Chem. Rev. 101 (12): 3793-3818 (2001)) highlights the most well characterized and widely used enzymes used for polymerization. Nonlimiting examples of these enzymatic classes include oxidoreductases (i.e., peroxidase, laccase, and bilirubin oxidase), which can be used for the polymerization of polyphenols, polyanilines, and vinyl polymers; transferases (i.e., phosphorylases, synthases, acyl transferases, and glycosyltransferases), which can be used for the polymerization of polysaccharides, cyclic oligosaccharides, and polyesters; hydrolases (i.e., glycosidases and lipases), which can be used for the polymerization of polysaccharides, polyesters, polycarbonates, and poly (amino acid)s; lyases; isomerases; and ligases. In addition, advances in genetic engineering allow the production of enzymes specifically designed for a reaction of interest. For example, enzymes can be engineered to have high efficiency, tight selectivity, or high stability in organic solvents. These enzymatic polymerization techniques and methods are within the scope of the present invention.

In a preferred embodiment, horseradish peroxidase (HRP) is used to polymerize the functionalized monomers. Horseradish peroxidase is an oxidoreductase isolated from plants that catalyses the oxidation of many phenolic and aromatic amines, mediated by hydrogen peroxide (Akkara, et al. J. Polym. Sci. Part A: Polymer Chemistry 29, 1561-1574 (1991); (Rao, et al. Biotechnology and Bioengineering 41, 531-540 (1993); Ayyagari et al. Macromolecules 28, 5192-5197. (1995); Kobayashi et al. Chem. Rev. 101, 3793-3818 (2001)). Generally, molar equivalents of monomer to hydrogen peroxide are used, although recent studies with vinyl monomers have shown that amount of the hydrogen peroxide can be reduced 40-50 fold compared to monomer with the addition of a β-diketone to facilitate the free-radical process (Singh et al. Biomacromolecules 1, 592-596 (2000); (Singh et al. J. Macromol. Sci.—Pur and Applied Chemistry A38, 1219-1230 (2001); (Kalra et al. Biomacromolecules 1, 501-505 (2000); (Teixeira et al. Macromolecules 32, 70-72 (1999); (Durand et al. Polymer 42, 5515-5521 (2001)). Horseradish peroxidase catalyzed polymerization of L-ascorbyl 4-vinylbenzoate (3) with oxidant hydrogen peroxide and initiator 2,4-pentanedione is shown in Example 3.

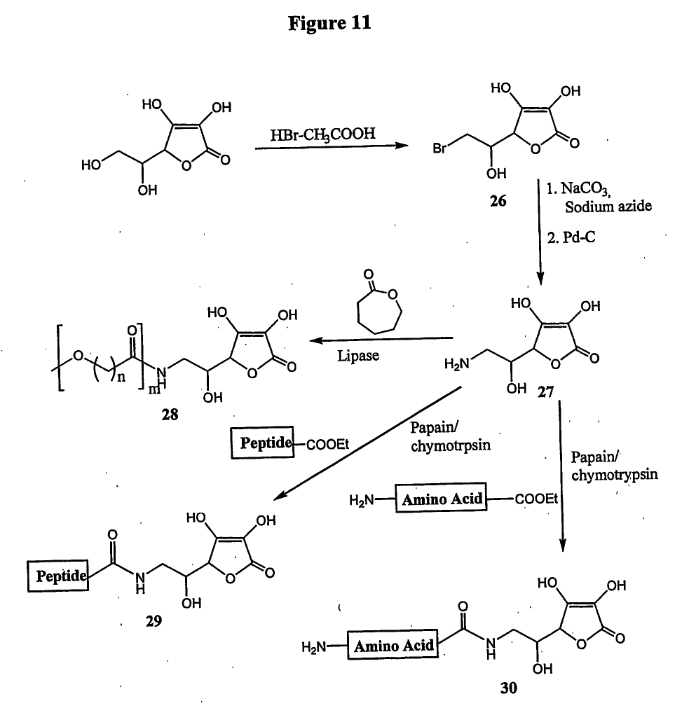

In one embodiment, the amino group of 6-deoxyamino L-ascorbate is used for lipase catalyzed ring opening polymerization of lactones, protease catalyzed coupling with peptide, enzymatic peptide formation with essential amino acid, non-essential amino acid and other amino acid that do not occur in proteins. As illustrated in FIG. 11, ascorbic acid can be transformed to 6-deoxybromoascorbate (26) by reacting ascorbic acid with hydrogen bromide in acetic acid. 6-deoxybromoascorbate is converted to 6-deoxyamino L-ascorbate by a well known procedure (Andrews, G. C. Carbohydrate Research 134, 321-326 (1984); Wimalasena, K. et al, Analytical Biochemistry 210, 58-62 (1993); Kojic-Prodic, M., European Journal of Medicinal Chemistry 31, 23-35 (1996)).

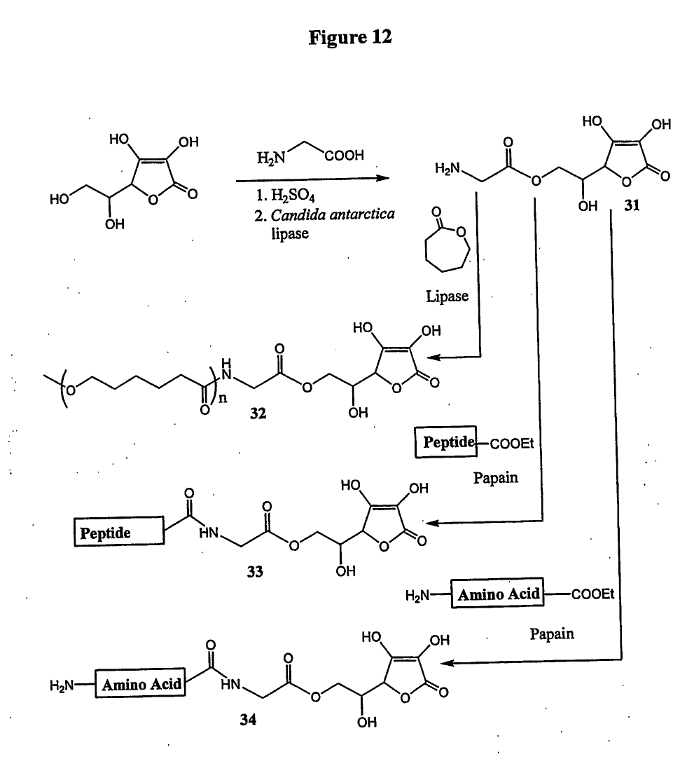

In another embodiment, amino acid functionalized ascorbic acid is used for the lipase catalyzed ring opening polymerization of lactones, protease catalyzed coupling with peptides and enzymatic peptide formation with essential amino acid, non-essential amino acid and other amino acid that do not occur in proteins. As illustrated in FIG. 12, the primary hydroxyl group of ascorbic acid is coupled with acid functional group of amino acids by using sulfuric acid in one experiment and Candida antarctica lipase in another experiment.

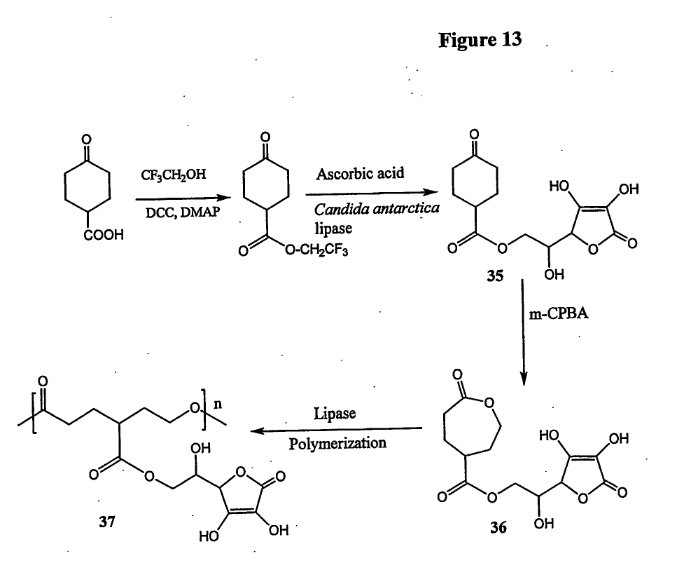

In another embodiment, lipase-catalyzed ring opening polymerization of lactones is carried out using lipases to produce ascorbic acid functionalized polymers. As illustrated in FIG. 13, L-ascorbyl-4-oxocyclohexane carboxylate (35) is produced by the regioselective acylation of ascorbic acid with trifluoroethy-4-oxocyclohenane carboxylate as previously described. Cyclic ketone is transformed to the corresponding lactone using m-chloroperoxybenzoic acid.

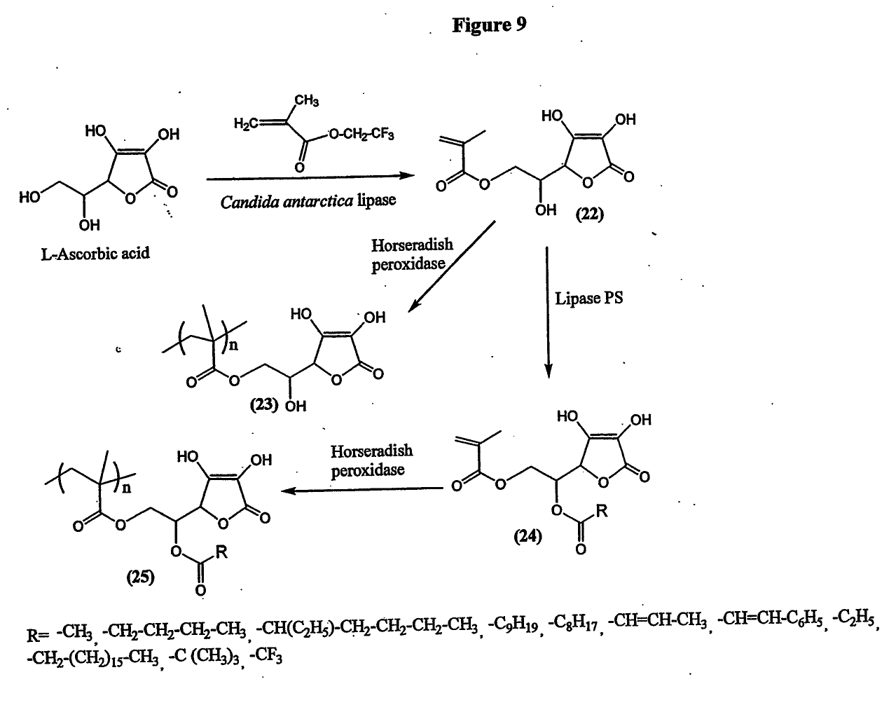

In yet another embodiment, enzymatically coupled ascorbic acid vinyl monomers can be enzymatically acylated prior to enzymatic polymerization. The primary hydroxyl of ascorbic acid at the C-6 position can be functionalized with vinyl group by using Candida antarctica lipase. In a second step, acylating reagents, such as esters of varieties of compounds like fatty acids, aromatic compounds, peptides, (i.e., vinyl 2-ethyl hexanoate, vinyl neodecanoate, vinyl neononanoate, vinyl decanoate, vinyl crotonate, vinyl cinnamate, vinyl propionate, vinyl stearate, vinyl pivalete, vinyltrifluoroacetate, etc.) can be added to the secondary hydroxyl group at C-5 position using lipase PS (Pseudomonas sp.) via an enzyme catalyzed transesterification approach (FIG. 9). These modifications control the characteristics of the resultant polymer, such as hydrophilicity and hydrophobicity without altering the backbone structure of the polymer.

III. Coupling Antioxidants to Biodegradable Polymers

A. Biodegradable Polymers

Biodegradable polymers have proven to be greatly important in medical applications over the last three decades. Polymers composed of lactic acid, glycolic acid, poly(dioxanone), poly(trimethylene carbonate) copolymers, and poly(caprolactone) homopolymers and copolymers are widely accepted for use as medical devices. Research continues on polyanhydrides, polyorthoesters, polyphosphazenes, and other biodegradable polymers. In one embodiment of the present invention, antioxidants can be enzymatically coupled to biodegradable monomers, such that the resulting biodegradable polymer retains antioxidant function. Non-limiting examples of biodegradable monomer comprise of polyesters, glycolides, lactides, trimethylene carbonates, caprolactones, dioxanone, hydroxybutyrates, hydroxyvalerates, carbonates, amino acids, “pseudo” amino acids, esteramides, anhydrides, orthoesters, saphorolactones, nucleosides, and biodegradable dendrimers and combinations thereof.

Antioxidant-coupled biodegradable polymers have a wide variety of uses as medical devices, controlled drug delivery, as well as packaging materials. In one embodiment, the antioxidant-coupled biodegradable polymer can be implanted into a subject, such that antioxidants are released upon degradation. The implanted antioxidant polymer may be used to help stabilize healing bones. The biodegradable polymer can be engineered such that the rate of degradation is slow enough so that the healing bone can accommodate the increasing load. The released antioxidants could help improve healing and regrowth.

Biodegradable polymers are tremendously useful as the basis for drug delivery, either as a drug delivery system alone or in conjunction to functioning as a medical device. In one aspect of the invention, a method of controlled delivery of an antioxidant to a subject is described in which antioxidants are coupled to biodegradable monomers, which can then be polymerized (see Example 3 and section on Enzymatic Polymerization). The resultant antioxidant coupled polymer degrades at a rate consistent with an effective administration rate of the antioxidant. The antioxidant bound to a biodegradable polymer in the controlled delivery system is present in an amount from about 20% to about 80% (w/w). Antioxidants are chosen based upon the application, and the biodegradable monomers may be either synthetic or natural. Natural antioxidants, such as ascorbic acid and tocopherols, not only preserve food and improve flavor, but also protect against pathological effects of free radicals which are associated with altered states such as cancer, cardiovascular disease and aging. The antioxidant coupled polymer may be cast into a shaped form from the group consisting of, but not limited to, a film, a fiber, a coating, a sheet, or combinations thereof. In one embodiment, the controlled delivery system may implanted into a subject. In another embodiment, the controlled delivery system may be ingested. In a third embodiment, the controlled delivery system may be used as a topical ointment.

In one embodiment, the controlled delivery system consists of an antioxidant coupled homopolymer matrix. In another embodiment, the antioxidant coupled polymer matrix is a copolymer. At least 1% of the monomeric units are functionalized with antioxidants, preferably 10%, more preferably at least 50%, and most preferably at least one antioxidant is coupled to each monomer. More than one antioxidant can be used in the controlled delivery system. For example, vitamin E (α-tocopherol) and vitamin C, which recycle each other, can both be coupled to the biodegradable polymers such that their controlled release would extend the oxygen scavenging abilities. Ascorbic acid can recycle tocopherol via TO● back to its effective antioxidant form of TOH producing an ascorbate radical, Asc●-. Ascorbic acid is then returned to its effective form through the reduction of the ascorbate radical via enzyme systems that use NADH and NADPH . Vitamin C and vitamin E are well suited for use in the present invention. Not only can they be efficiently recycled, their thermodynamic and kinetic properties make their radicals relatively harmless while being efficient antioxidants in small concentrations (Buettner, G. R. Arch Biochem. Biophys. 300 (2): 535-543 (1993)).

B. Controlled Drug Delivery System

The present invention can be used as a controlled drug delivery system, providing sustained release of the antioxidant from the polymer matrix. The delivery system can be used to treat free radical associated disorders as well as decrease oxidative stress. In one embodiment, the antioxidant coupled to the biodegradable polymer can be a vitamin which acts as a biological antioxidant, including, but not limited to, β-carotene, vitamin A, vitamin C and vitamin E. These vitamins appear to work at different levels of carcinogenesis. (Stahelin et al., Am J Epidemiology 133:766-775 (1991)). β-carotene may act as a scavenger for free radicals in the body. Vitamin A (retinol) has been recognized as being able to interfere with carcinogenesis. (See Goodman Gilman, The Pharmacological Basis of Therapeutics, Pergamon Press, New York (1990)). It is likely that vitamin A acts at the promotion or progression phase of carcinogenesis. Vitamin C (ascorbic acid) may also act as an antioxidant by preventing nitrosamine formation in the stomach and reducing fecal mutagenicity. Vitamin E (α-tocopherol), when acting as an antioxidant, may inhibit the formation of carcinogenic promoters by protecting essential cellular constituents, such as the polyunsaturated fatty acids of cell membranes, from peroxidation and by preventing the formation of toxic oxidation products. These and other physiologically acceptable antioxidants are within the scope of the invention. Also within the scope of the invention are combinations of antioxidants.

The dosage range for other physiologically acceptable antioxidants is determined by reference to the usual dose and manner of administration of the antioxidant. For example, a range of from about 15 mg to about 1000 mg/day of vitamin E; from about 50 mg to about 2000 mg/day of vitamin C; from about 900 μg to about 3000 μg/day of vitamin A, from about 50 μg to 400 μg/day of selenium, and from 5 to 30 μg/day of carotenoid. The composition or combination of agents should be administered in amounts sufficient to ensure that the serum level of antioxidants is maintained at an appropriate level or restored or increased to an appropriate level while serum cholesterol levels are reduced.

One or more physiologically acceptable antioxidants can be coupled to the polymer and thus administered to a subject upon polymer degradation as compositions by various known methods, such as by injection (subcutaneous, intravenous, etc.), oral administration, inhalation, transdermal application, or rectal administration. Depending on the route of administration, the antioxidant-coupled polymer may be coated with a material to protect the compound from the action of acids and other natural conditions which may inactivate the antioxidant. The composition can further include both the antioxidant and a cholesterol-lowering agent. The composition comprises at least 1% of the resultant polymer's monomer units with antioxidants, preferably at least 10%, and more preferably at least 50%. More preferably, at least one antioxidant is coupled per monomer unit. The antioxidant is present in the resultant antioxidant-coupled polymer comprises 20% to 80% (w/w).

Pharmaceutical compositions suitable for injectable use include sterile aqueous solutions (where water soluble) or dispersions and sterile powders for the extemporaneous preparation of sterile injectable solutions or dispersion. In all cases, the composition must be sterile and must be fluid to the extent that easy syringability exists. It must be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol, and liquid polyetheylene gloycol, and the like), suitable mixtures thereof, and vegetable oils. The proper fluidity can be maintained, for example, by the use of a coating such as licithin, by the maintenance of the required particle size in the case of dispersion and by the use of surfactants. Prevention of the action of microorganisms can be achieved by various antibacterial and antifungal agents. In many cases, it will be preferable to include isotonic agents, for example, sugars, polyalcohols such as manitol, sorbitol, sodium chloride in the composition. Prolonged absorption of the injectable compositions can be brought about by including in the composition an agent which delays absorption, for example, aluminum monostearate and gelatin.

Sterile injectable solutions can be prepared by incorporating the composition containing the antioxidant in the required amount in an appropriate solvent with one or a combination of ingredients identified above, as required. Generally, dispersions are prepared by incorporating the composition into a sterile vehicle which contains a basic dispersion medium and the required other ingredients from those identified above.

When the antioxidant-coupled polymer is suitably protected, as described above, the composition may be orally administered, for example, with an inert diluent or an assimilable edible carrier. The composition and other ingredients may also be enclosed in a hard or soft shell gelatin capsule, compressed into tablets, or incorporated directly into the subject's diet. For oral therapeutic administration, the composition may be incorporated with excipients and used in the form of ingestible tablets, buccal tablets, troches, capsules, elixirs, suspensions, syrups, wafers, and the like. The percentage of the compositions and preparations may, of course, be varied. The amount of active compound in such therapeutically useful compositions is such that a suitable dosage will be obtained.

The tablets, troches, pills, capsules and the like may also contain a binder, an excipient, a lubricant, or a sweetening agent. Various other materials may be present as coatings or to otherwise modify the physical form of the dosage unit. For instance, tablets, pills, or capsules may be coated with shellac, sugar or both. Of course, any material used in preparing any dosage unit form should be pharmaceutically pure and substantially non-toxic in the amounts employed. As used herein “pharmaceutically acceptable carrier” includes any solvents, dispersion media, coatings, antibacterial and antifungal agents, isotonic and absorption delaying agents, and the like. The use of such media and agents for pharmaceutically active substances is well known in the art. Except insofar as any conventional media or agent is incompatible with the active compound, use thereof in compositions of the invention is contemplated.

In another embodiment, a pharmaceutical agent or neutraceutical can be embedded in the antioxidant-coupled biodegradable polymer. In yet another embodiment, the antioxidant-coupled biodegradable polymer can be cast around or used to coat a pharmaceutical agent or neutraceutical. An oxygen sensitive pharmaceutical agent or neutraceutical will be protected from degradation and released in a sustained manner to a subject as described above.

It is especially advantageous to formulate compositions of the invention in dosage unit form for ease of administration and uniformity of dosage. “Dosage unit form” as used herein refers to physically discrete units suited as unitary dosages for the subjects to be treated. Each dosage contains a predetermined quantity of active compound calculated to produce the desired therapeutic effect in association with the required pharmaceutical carrier. The specification for the novel dosage unit forms of the invention is dependent on the unique characteristics of the composition containing the antioxidant and the particular therapeutic effect to be achieved. Dosages are determined by reference to the usual dose and manner of administration of the ingredients.

IV. Uses

A. Controlled Delivery System

Many disorders or diseases arise due to oxidative stress and the presence of free radicals. The methods and compositions of the invention can be used to prevent, slow down or treat disorders associated with antioxidant levels and excess free radicals. The present invention can be used to control the release of antioxidants into the body, which would be useful to maintain proper levels of antioxidants in the body. Antioxidants coupled to biodegradable polymers improve stability of the antioxidant as well as allow control over their release from the polymer. The coupled-antioxidant is present in an amount from 20% to about 80% (w/w) of the total composition. Non-limiting examples of disorders that arise due to altered levels of antioxidants include, aging at a higher than normal rate, segmental progeria disorders, Down's syndrome; heart and cardiovascular diseases such as atherosclerosis, adriamycin cardiotoxicity, alcohol cardiomyopathy; gastrointestinal tract disorders such as inflammatory & immune injury, diabetes, pancreatitis, halogenated hydrocarbon liver injury; eye disorders such as cataractogenesis, degenerative retinal damage, macular degeneration; kidney disorders such as autoimmune nephrotic syndromes and heavy metal nephrotoxicity; skin disorders such as solar radiation, thermal injury, porphyria: nervous system disorders such as hyperbaric oxygen, Parkinson's disease, neuronal ceroid lipofuscinoses, Alzheimer's disease, muscular dystrophy and multiple sclerosis; lung disorders such as lung cancer, oxidant pollutants (O₃,NO₂), emphysema, bronchopulmonary dysphasia, asbestos carcinogenicity; red blood cell disorder such as malaria Sickle cell anemia, Fanconi's anemia and hemolytic anemia of prematurity; iron overload disorders such as idiopathic hemochromatosis, dietary iron overload and thalassemia; inflammatory-immune injury, for example, glomerulonephritis, autoimmune diseases, rheumatoid arthritis; ischemia reflow states disorders such as stroke and myocardial infarction; liver disorder such as alcohol-induced pathology and alcohol-induced iron overload injury; and other oxidative stress disorders such as AIDS, radiation-induced injuries (accidental and radiotherapy), general low-grade inflammatory disorders, organ transplantation, inflamed rheumatoid joints and arrhythmias. The method of the invention can be used for treatment and/or prevention of a free radical induced disorder, or an oxidative stress disorder.

B. Food Packaging

Lipids in biological systems are highly susceptible to oxidation leading to deterioration. In food, lipid oxidation leads to rancidity, loss of nutritional value resulting from the destruction of vitamins (A, D, and E) and essential fatty acids, and the possible formation of toxic compounds as well as flavor and color changes. Lipid oxidation is a major problem facing the meat industry. Rapid onset of rancidity in cooked meats during refrigerated storage, warmed over flavor, is detectable in 48 hours in cooked meats. Raw meat that had been ground and exposed to air rapidly develops warmed over flavor during refrigeration. The oxidative stability of meat is related to the degree of saturation of the lipid fraction, with chicken being most susceptible, followed by pork, beef and lamb. Adding antioxidants directly to foodstuff is a common method of food preservation. However, this method may have harmful side effects, such as allergies and accumulation of toxic levels of antioxidant. In an attempt to overcome the shortcomings of present food preservation techniques, a novel polymer containing covalently coupled functional antioxidants was invented. The invention can be used as packaging for foodstuff providing protection from oxygen degradation; moreover, the antioxidant will not leach out of the polymer and thus does not get absorbed into the body.

C. Biomedical

Cardiovascular disease including atherosclerosis is a common cause of death in chronic renal failure patients on long term hemodialysis. Such disease states have been linked to high levels of oxidative stress. A recent study of haemodialysis patients (Morena et al. Nephrol. Dial. Transplant. 17:422-427 (2002)) found that dialysis leads to a decrease in antioxidant defenses due to impaired enzyme activities and dramactically decreased plasma levels of ascorbic acid. Dialysis increases oxidatitive stress both through an increase in ROS production and a decrease in defense mechanisms, such as superoxide dismutase activity in erythrocytes and a decreased plasma glutathione peroxidase activity. In addition, many antioxidant vitamins get altered in uraemia. Therefore, ways to maintain or increase antioxidant levels, especially vitamin C which is known to be depleted through dialysis, are needed. The present invention can be used to slow or prevent the antioxidant depletion by coating the inside of the dialysis tubing with antioxidant coupled polymers. The antioxidant could be chosen from the group consisting of ascorbic acid, vitamin E derivatives, tocol, α-tocopherol, β-tocopherol, γ-tocopherol, φ-tocopherol, ε-tocopherol, ξ1-tocopherol, ξ2-tocopherol, η-tocopherol, vitamin B derivatives, thiamine, cyanocobalamin, ergocalciferol, cholecalciferol, vitamin K derivatives, phytonadione, menaquinone, quercetin, vitamin A derivatives, retinol, retinal, 3,4-didehydroretinol, α-carotene, β-carotene, δ-carotene, γ-carotene, cryptoxanthin, citric acid, butylated hydroxyanisole, butylated hydroxytoluene, alpha-lipoic acid, glutathione, carotenoids, allylic sulfides, selegiline, N-actylcysteine, lecithin, tartaric acid, caffeic acid, diaryl amines, thioethers, quinones, tannins, xanthenes, procyanidins, porphrins, phenolphthalein, indophenol, coumarins, flavones, flavanones, and isomers, derivatives, and combinations thereof.

In a preferred embodiment, an ascorbic acid coupled polymer could coat the inside of a biomedical conduit, such as dialysis tubing or catheter. Ascorbic acid coupled polymers can have multiple benefits including decreasing ascorbic acid depletion and recycling vitamin E. Vitamin E is a well characterized peroxyl scavenger that prevents lipid peroxidation. Its antioxidant function has been shown to depend on the presence of vitamin C. Alpha tocopherol is regenerated from tocopheroxyl radicals; thus, vitamins E can be maintained in its non-radical reduced form.

D. Manufacturing

Virtually all of the billions of pounds of thermoplastic resins used throughout the world each year require the addition of chemical stabilizers to protect them from heat, oxidation and mechanical stresses encountered in the conversion processes for fabricated products. Increased stabilization will be needed to protect these products from deterioration through their expected life. Antioxidants are used to permit processing of thermoplastics and to provide in-service protection of the converted products. In one embodiment, the present invention could be used to coat the inside of the vessels used in the manufacturing of the resins. In another embodiment, the methods of the present invention may be used to couple an antioxidant to the resins to directly protect from degradation and improve stability.

E. Topical Applications and Cosmetics

Photoaging, sagging skin and other signs of degenerative skin conditions, such as wrinkles and age spots are caused primarily by free radical damage. Vitamin C has been shown to accelerate wound healing, protect fatty tissues from oxidation damage, as well as play an integral role in collagen synthesis (Zhang et al., Bioelectrochem Bioenerg 48:453-61 (1999)). Clinical studies show that antioxidants in a cosmetic vehicle can inhibit the induction of lipid peroxidation in stratum corneum lipids, which are produced endogenously or induced by UVB exposure (Pelle et al., Photodermiatol Photoimmunol Photomed 15:115-119 (1999)). α-Tocopherol has been shown to be the major antioxidant in the human stratum corneum. Depletion of a-tocopherol is an early and sensitive biomarker of environmentally induced oxidation. Topical and/or systemic application of antioxidants could support physiological mechanisms that maintain or restore a healthy skin barrier and protect the skin from environmental stresses that may lead to UV-induced carcinogenesis, photoaging, or desquamatory skin disorders (Thiele et al., Curr Probl Dermatol 29:2642 (2001)).

The methods and compositions of the invention can be used to treat or protect from oxygen radicals that get produced by cells when exposed to UV light, injury, infection or drugs. In one embodiment, the antioxidant functionalized polymers can be used topically, such as an ointment, spray, cream, or lotion. In another embodiment, the release of antioxidants from the polymer matrix to the skin can be controlled. Antioxidants can be attached to the polymer such that a reaction that would cleave the antioxidant from the matrix can be controlled. Non-limiting examples could include the use of a photosensitive reaction or light inducible enzymatic reaction catalyzed by a heat or light inducible enzyme that may be added to the topical composition.

In another embodiment, the present invention can be used in the topical treatment of viral lesions. Studies on mice and guinea pigs (Sheridan et al. Antiviral Res. 36: 157-166 (1997)) indicate that topical application of antioxidants, such as a formulation of vitamin E, sodium pyruvate and membrane stabilizing fatty acids may be useful in the reduction of the development, duration, and severity of lesions due to genital herpes simplex virus.

One or more physiologically acceptable antioxidants composition can be formulated in a form suitable for topical application. For example, as a lotion, aqueous or aqueous-alcoholic gels, vesicle dispersions or as simple or complex emulsions (O/W, W/O, O/W/O or W/O/W emulsions), liquid, semi-liquid or solid consistency, such as milks, creams, gels, cream-gels, pastes and sticks, and can optionally be packaged as an aerosol and can be in the form of mousses or sprays. The composition can also be in a sunscreen. These compositions are prepared according to the usual methods. The composition can be packaged in a suitable container to suit its viscosity and intended use by the consumer. For example, a lotion or cream can be packaged in a bottle or a roll-ball applicator, or a propellant-driven aerosol device or a container fitted with a pump suitable for finger operation. When the composition is a cream, it can simply be stored in a non-deformable bottle or squeeze container, such as a tube or a lidded jar. The composition may also be included in capsules such as those described in U.S. Pat. No. 5,063,507.

A suitable dermatologically acceptable carrier must be chosen that is adequate for topical use, compatible with the coupled antioxidant, and will not add toxicity. An effective and safe carrier varies from about 50% to about 99% by weight of the compositions of the invention, preferably from about 75% to about 99%, and more preferably from about 85% to about 95%. The pharmaceutically acceptable excipient and biological or cosmetic agent to be used in conjunction with the present invention is dependent upon the intended use.

Antioxidants, which may be used in the present invention as anti-wrinkling and/or anti-aging agents may include, but are not limited to, retinoids (for example, retinoic acid, retinol, retinal, retinyl acetate, and retinyl palmitate) alpha hydroxy acids, galactose sugars (for example, melibiose and lactose), antioxidants, including but not limited to water soluble antioxidants such as sulfhydryl compounds and their derivatives (for example, sodium metabisulfite and N-acetyl-cysteine, acetyl-cysteine), lipoic acid and dihydrolipoic acid, resveratrol, lactoferin, ascorbic acid and ascorbic acid derivatives (for example ascorbyl palmitate and ascorbyl polypeptide). Oil soluble antioxidants suitable for use in the compositions of this invention include, but are not limited to tocopherols (for example, tocopheryl acetate, alpha-tocopherol), tocotrienols and ubiquinone. Antioxidants isolated from natural extracts are suitable for use in this invention, These include, but are not limited to, flavonoids, phenolic compounds, flavones, flavanones, isoflavonoids, mono, di- and tri-terpenes, sterols and their derivatives. Flavonoids are a major source of plant phenols that have demonstrated antioxidant capabilities. Rosemary contains a number of compounds possessing antioxidant activity, such as carnosol, rosmanol, rosmariquinone, and rosmaridiphenol. Other sources of these compounds include grape seed, green tea, pine bark and propolis extracts and legume extracts and the like.

This invention is further illustrated by the following examples which should not be construed as limiting. The contents of all references, patents and published patent applications cited throughout this application, are incorporated herein by reference.

### EXAMPLES

### Example 1

### Materials and Methods

(i) Materials

Horseradish peroxidase (Type II, 150-200 units/ mg solid) and hydrogen peroxide (30% w/w) were purchased from Sigma Chemical Co., St. Louis, Mo. 4-Vinyl benzoic acid, trifluoroethanol, N,N-dimethylaminopyridine, dicyclohexyldicarbodiimide, tetrahydrofuran, dioxane, L-ascorbic acid, triethylamine, 2,2-diphenyl-1-picryl hydrazyl radical (DPPH●) and 2,6-di-tert-butyl-4-methylphenol were purchased from Aldrich Chemical Co., Milwaukee, Wis. Solvents used were high performance liquid chromatography grade and purchased from Fischer Scientific Co., Pittsburg, Pa. Candida antarctica lipase, immobilized, was a gift from NovoNordisk Co.

¹H NMR and ¹³C NMR spectra were recorded using a Bruker DPX 300 spectrometer. Chemical shifts in parts per million (ppm) were referenced relative to tetramethylsilane (TMS, 0.00 ppm) as internal reference.

(ii) Synthesis of trifluoroethyl 4-vinylbenzoate

p-Vinylbenzoic acid (1) (5.0 g, 33.74 mM), trifluoroethanol (4.9 mL, 67.48 mM), 4-(dimethylamino)pyridine (4.968 g, 40.49 mM) and 1,3-dicyclohexylcarbodiimide (DCCI, 8.355 g, 40.49 mM) were stirred in 100 mL tetrahydrofuran at 25° C. for 24 hours. 75 mg of 2,6-di-tert-butyl-4-methylphenol was added to the reaction mixture to avoid vinyl polymerization during solvent evaporation. Reaction was monitored by silica gel thin layer chromatography. Crude product was purified using silica gel column chromatography with eluent consisting of chloroform:hexane in 15: 85 ratio. Trifluoroethyl 4-vinylbenzoate (2) was isolated in 94% yield and analyzed by NMR: ¹H NMR (CDCl₃): 4.68 (2H, q, —CH₂—CF₃), 5.40 (1H, d, J=10 Hz, —CH═CH₂), 5.87(1H, d, J=17 Hz, —CH═CH₂), 6.74(1H, dd, J=10 Hz, 12 Hz, —CH═CH₂), 7.46 (2H, m, aromatic protons), and 8.02 (2H, m, aromatic protons). ¹³C NMR (CDCl₃): 24.8, 25.6, 30.4, 35.1(—CH₂CF₃), 60.1, 60.6, 61.1, 61.6 (—CH₂—CF₃), 117.2 (—CH═CH₂), 135.9 (—C H═CH₂), 126.4, 127.6, 130.5, 143.0 (aromatic carbons), and 164.8 (—C═O).

### Example 2

### Enzymatic Coupling of Ascorbic Acid to a Vinyl Monomer: Synthesis L-ascorbyl 4-vinylbenzoate (3) and L-ascorbyl methylmethacrylate (22)

The possible chemical pathway which results in major degradation products involves the primary hydroxyl group of ascorbic acid. The primary hydroxyl group was regioselectively protected via mild enzyme catalysed transesterification reaction which stops degradation and an active ascorbic acid was attached to the vinyl monomer (FIG. 1). This synthesis can be done was done as follows:

(i) Synthesis L-ascorbyl 4-vinylbenzoate (3)

Immobilized Candida antarctica lipase and L-ascobic acid were dried under high vacuum in a desicator with phosphorous pentoxide for 24 hours prior to reaction. The reaction approach was an enzymatic transesterification where the primary hydroxyl group of ascorbic acid is regioselectively acylated by trifluoroethyl 4-vinylbenzoate (2) via the acyl enzyme complex. In a typical reaction, L-ascorbic acid (2.0 g, 11.35 mM), trifluoroethyl 4-vinylbenzoate (2) (2.611 g, 11.35 mM), Candida antarctica lipase (10 g, immobolized) were stirred in 40 mL of anhydrous dioxane at 60° C. 75 mg of 2,6-di-tert-butyl-4-methylphenol was added to the reaction mixture to avoid vinyl polymerization at 60° C. and during solvent evaporation. Reactions were monitored by thin layer chromatography. Enzyme was filtered, washed thoroughly with dioxane and solvent was evaporated by rotary evaporation under reduced pressure. NMR was performed to confirm the presence of the reaction product, L-ascorbyl 4-vinylbenzoate (3). ¹H NMR (CD₃ OD): 4.27 (1H, m, —CH—OH), 4.46 (2H, m, —CH₂—O), 4.85(1H, d, —CH—O), 5.39 (1H, d, J=10 Hz, —CH═CH₂), 5.93 (1H, d, J=9 Hz, —CH═CH₂), 6.80 (1H, dd, J=10 Hz & 10 Hz, —CH═CH₂), 7.54 and 8.02 (aromatic protons). ¹³C NMR (CD₃OD): 63.6(—CH2—O), 68.2 (CH—OH), 76.9 (C H—O), 117.2 (CH═CH₂), 120.2 (═C—OH), 137.3 (CH═CH₂), 127.3, 130.2, 131.1, 143.8 (aromatic protons), 154.8 (═C—OH), 167.6 (Ar—C═O(O)), 173.6(—C═O(O)). In the ¹H-NMR spectrum of L-ascorbyl 4-vinyl benzoate (3), C-6H (methylene protons) appeared at δ 4.47 which otherwise appeared at δ 3.68 in ascorbic acid. This downfield shift indicated the formation of an ester involving the C-6-OH group. In addition the integral ratio of vinyl phenyl protons and ascorbic acid corresponded to a mono acylated product. In the ¹³C-NMR spectrum of L-ascorbyl 4-vinylbenzoate (3), the C-6, methylene carbon appeared at δ 77.45 which otherwise appeared at 63.60 in ascorbic acid, indicating ester formation with C-6-O. No significant shift was observed in the C-2, C-3, or C-5 carbons. Furthermore, the study of integral values of ¹H-NMR signals, as well as peak positions in proton and carbon NMR, confirmed that the expected product was formed.

(ii) Synthesis of L-ascorbyl methylmethacrylate (22)

Immobilized Candida antarctica lipase and L-ascorbic acid were dried under high vacuum in a desicator with phosphorous pentoxide for 24 hours prior to reaction. The reaction utilized an enzymatic transesterification where the primary hydroxyl group of ascorbic acid was regioselectively acylated by 2,2,2-trifluoroethyl methacrylate via the acyl enzyme complex. In a typical reaction, L-ascorbic acid (15.0 g, 85.2 mM), 2,2,2-trifluoroethyl methacrylate (18.2 mL, 127.8 mM), C. antarctica lipase (20 g, immobilized) were stirred in 300 mL of anhydrous dioxane at 60° C. 250 mg of 2,6-Di-tert-butyl-4-methylphenol was added to the reaction mixture to avoid vinyl polymerization at 60° C. and during solvent evaporation. Reactions were monitored by thin layer chromatography. The enzyme was filtered, the product washed thoroughly with dioxane and solvent was evaporated by rotary evaporation under reduced pressure. ¹H NMR(CD₃OD): δ 1.98 (3H, s, —CH₃), 4.17 (1H, m, C-5H), 4.33 (2H, m, C-6H), 4.79 (1H, d, C-4H), 5.68 (1H, m, C-9H), 6.91 (1H, s, C-9H). ¹³C NMR (CD₃OD): δ 18.5 (C-10), 63.6 (C-4), 66.3 (C-5), 77.3 (C-6), 120.1 (C-2), 126.9 (C-9), 137.4 (C-8), 154 (C-3), 168.6 (C-7), 173.2 (C-1).

### Example 3

### Enzymatic Polymerization of L-ascorbyl 4-vinylbenzoate (3) and L-ascorbyl methylmethacrylate (22)

(i) Polymerized L-ascorbyl 4-vinylbenzoate (4)

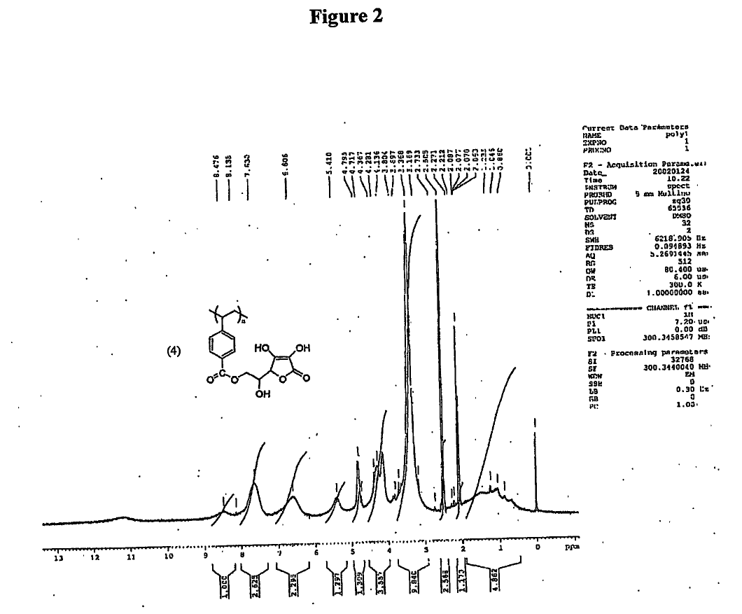

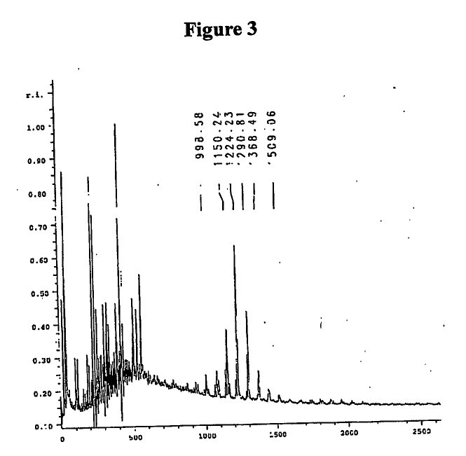

The vinyl monomer functionalized with ascorbic acid was polymerized with horseradish peroxidase using initiator 2,4-pentanedione and oxidant hydrogen peroxide in 50:50 water and methanol. 2,4-Pentanedione was distilled under vacuum before use. In a general procedure, 1.8 mL water, 2.0 mL methanol were flushed with nitrogen for 10 min. L-ascorbyl 4-vinylbenzoate (3) (457 mg, 1.5 mM) was added to the reaction mixture. Horseradish peroxidase (3.56×10⁻⁴ mM, 2400 units, 16 mg) was dissolved in 200 μL of water. Hydrogen peroxide, 0.15 mM (17 μL), and 0.30 mM of 2,4-pentanedione were added simultaneously after the addition of the enzyme. Polymerization was conducted for 24 h with continuous stirring. The reaction mixture was poured into 200 mL methanol. No solid product was obtained. The polymer was soluble in excess of methanol. The excess methanol was evaporated and the crude product was washed with acetone to remove the unpolymerized monomer. The product, polymerized L-ascorbyl 4-vinylbenzoate (4), was dried under vacuum and analyzed by NMR (FIG. 2) and MALDI-TOF mass spectrum (FIG. 3). The ¹H-NMR spectrum of polymerized L-ascorbyl 4-vinylbenzoate (4) (FIG. 2) showed the presence of methylene and methine protons at δ 0.85 to 2.75 and an absence of vinyl protons at δ 5.39, 5.93, & 6.80, indicating successful vinyl polymerization. Aromatic protons appear as broad singlets at δ 6.60 & 7.63. Furthermore the presence of C-5 and C-6 protons at δ 4.13 to 4.63 confirmed that the vinyl group was polymerized and ascorbic acid was attached as pendent group through a C-6-O linkage. MALDI-TOF MS (FIG. 3) showed a polymer with Mn=1225 (ds=1, DP=4), PD=1.03. In a separate experiment, the soluble fraction of the polymer with Mw=7000 was analyzed by MALDI-TOF. The product containing the higher molecular weight fraction (above Mw 7000) was also analyzed by MALDI-TOF, but due to lack of solubility could not be fully assessed. This solution behavior suggests significantly higher molecular weight than 7,000 Da, and based on film forming behavior, further supports this assessment.

(ii) Polymerized L-ascorbyl methylmethacrylate (23)

In a general procedure of polymerization of L-ascorbyl methylmethacrylate, 5.0 mL water and 10 mL tetrahydrofuran were flushed with nitrogen for 15 min. L-Ascorbyl methylmethacrylate (22) (2.0 g, 8.2 mM) was added to the reaction mixture. Horseradish peroxidase (16 mg) was dissolved in 200 μL of water. Hydrogen peroxide, 0.82 mM (93 μL), and 1.64 mM (177 μL) of 2,4-pentanedione were added simultaneously after the addition of the enzyme. Polymerization was conducted for 24 h with continuous stirring.

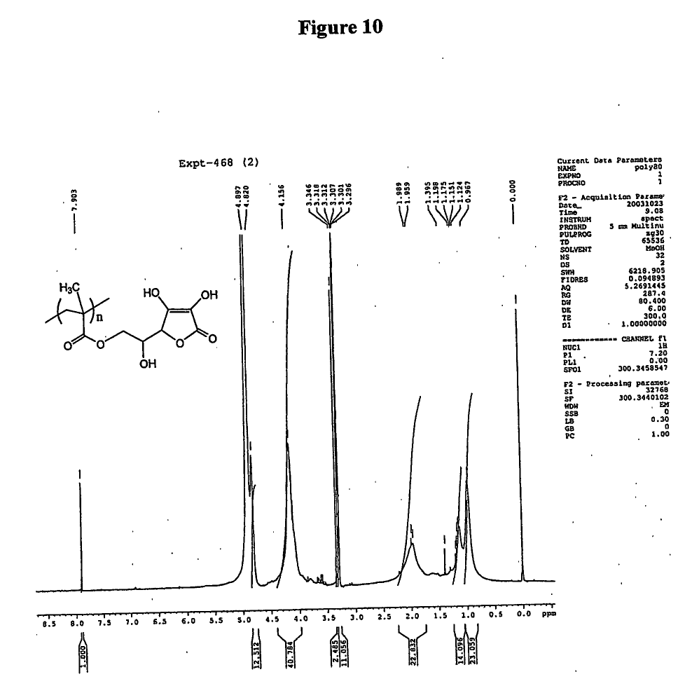

In the ¹H NMR spectrum (FIG. 10) of polymerized L-ascorbyl methylmethacrylate (23), two protons corresponding to vinyl group disappear from δ 5.68 & 6.91 and new broad peak at δ 1.95 appear for methylene protons indicating the polymerization of vinyl group. Methyl protons which appear as singlet at δ 1.98 in the case of starting monomer appear as two broad peaks at δ 1.2. In ¹³C NMR peaks belonging to ascorbic acid part appear in respective δ values while peaks at δ 126.9 & 137.4 for vinyl carbons disappear and new peaks for polymerized backbone appear at δ 28.1, 29.9 and 45.1.

### Example 4

### Scavenging effect of Polymerized L-ascorbyl 4-vinylbenzoate (4) on DPPH●

The antioxidant activity of polymer L-ascorbyl 4-vinylbenzoate (4) and ascorbic acid were compared by measuring their scavenging effect on 2,2-diphenyl-1-picrylhydrazyl (DPPH) radicals using known methods (Chen et al. J. Agric. Food Chem. 47, 2226-2228 (1999); (Duh et al. J. Agric. Food Chem. 49, 1455-14 (2001)). Antioxidant activity can be measured in terms of radical scavenging, according to DPPH radical method as detailed by the equation below.
Ascorbate+DPPH^{●}→Ascorbate^{●}+DPPH—H

The reduction of DPPH^{●} by the ascorbyl-coupled polymer results in the decrease of the optical absorbance at 514 nm of the purple-blue colored solution of DPPH^{●} in methanol. Test compound and DPPH (final conc. 0.2 mM) pre-dissolved in methanol were thoroughly mixed and the solution were kept at room temperature in dark for 30 min. Thereafter the absorbance of the samples was measured using a spectrophotometer (HP 8452, diode Array Spectrophotometer, MS-DOS UV/VIS) at 514 nm. Methanol without DPPH was used as reference. Up to 238 μM conc. poly(L-ascorbyl 4-vinylbenzoate) fully scavenged the DPPH radical. Each sample was run in triplicate, and the values were averaged (Table 1).

TABLE 1
Scavenging effect of polymer of L-ascorbyl
4-vinylbenzoate (4) on DPPH.

| | | Concentration | |
|---|---|---|---|
| Rx. No. | Compound | (μM) | Absorbance at 514 nm^{a} |
| 1. | DPPH (blank) | — | 1.12 ± 0.01 |
| 2. | Ascorbic acid | 329^{b} | —^{c} |
| 3. | Ascorbic acid | 187^{b} | — |
| 4. | Ascorbic acid | 91^{b} | 0.12 ± 0.01 |
| 5. | Polymer | 663 | — |
| 6. | Polymer | 330 | — |
| 7. | Polymer | 238 | — |
| 8. | Polymer | 189 | 1.0 ± 0.00 |
| 9. | Polymer | 132 | 1.39 ± 0.01 |
| 10. | Polymer | 91 | 1.67 ± 0.01 |
| 11. | Polymer | 58 | 1.87 ± 0.01 |

^{a}reactions were performed in triplicate; average ± standard deviation.
^{b}amount of ascorbic acid used instead of polymer.
^{c}indicates all DHHP scavenged by compound.

### Example 5

### Enzymatic Polymerization of L-Ascorbyl 4-hydroxy phenyl acetate (7) following Enymatic Coupling of Ascobic Acid to Trifloroethyl-4-Hydroxyphenyl Acetate (6)

The enzymatic coupling of ascorbic acid to an aromatic phenolic monomer followed by enzymatic polymerization is shown in this Example.

(i) Synthesis of Trifluoroethyl 4-hydroxyphenyl acetate (6)

As illustrated in FIG. 4, p-hydroxyphenylacetic acid (5) (15 g, 0.099 mol), trifluoroethanol (15 mL, 0.197 mol), 1,3-dicyclohexylcarbodiimide (24.4 g, 0.118 mol), and 4-(dimethylamino)pyridine (14.45 g, 0.118 mol) were stirred at 25° C. for 24 hours. The reaction was monitored by silica gel thin layer column chromatography. The crude product was purified using silica gel column chromatography with the eluent consisting of ethylacetate: petroleum ether in 25:75 ratio. Trifluoroethyl 4-hydroxyphenyl acetate (6) was isolated in 60% yield and analyzed by NMR. ¹H NMR (CDCl₃): δ 3.64 (2H, s, C-7H), δ 4.45 (2H, q, —CH₂—CF₃), δ 6.75 (2H, d, ArH), δ 7.10 (2H, d, ArH). ¹³C NMR (CDCl₃): δ 39.82 (C-7), δ 60.85 (—CH₂CF₃), 115.87 (C-2 & C-6), 124.87 (C-4), 130.69 (C-3 & C-5), 155.27 (C-1), and 171.19 (C-8).

(ii) Enzymatic Coupling of Ascorbic Acid to a Phenolic Monomer: Synthesis of L-ascorbyl 4-hydroxyphenyl acetate (7)

In a typical reaction, L-ascorbic acid (5.39 g, 0.030 mol), trifluoroethyl 4-hydroxyphenyl acetate (6) (10.733 g, 0.046 mol), Candida antarctica lipase (10 g, immobilized) were stirred in 100 mL of anhydrous dioxane at 60° C. for 24 hours as shown schematically in FIG. 4. Reactions were monitored by thin layer chromatography using solvent system methanol:chloroform in 1:1 ratio. The enzyme was filtered out, the product washed thoroughly with dioxane and solvent was evaporated by rotary evaporation under reduced pressure. The product, L-ascorbyl 4-hydroxyphenyl acetate (7), was isolated in 96% yield and analyzed by NMR. ¹H NMR (CD₃OD): δ 3.64 (2H, s, C-7H), δ 4.08 (1H, m, C-5′H), δ 4.22 (2H, m, C-6′H), δ 4.66 (1H, d, C-4′H), δ 6.74 (2H, m, ArH), and δ 7.09 (2H, m, ArH). ¹³C NMR (CD₃OD): δ 40.97 (C-7), δ 63.65, 68.17 (C-4′ & C-5′), δ 77.21 (C-6′), δ 116.37 (C-2 & C-6), δ 120.11 (C-2′), δ 126.29 (C4), δ 131.50 (C-3 & C-5), δ 154.16 (C-3′), δ 157.57 (C-1), δ 173.82, 173.25 (C-1′ & C-8).

(iii) Enzymatic Polymerization of L-ascorbyl 4-hydroxyphenyl acetate (7): Synthesis of Polymerized L-ascorbyl 4-hydroxyphenyl acetate (8)

The phenolic monomer functionalized with ascorbic acid (7) can be polymerized with horseradish peroxidase using initiator 2,4-pentanedione and oxidant hydrogen peroxide in 50:50 water and methanol. 2,4-Pentanedione can be distilled under vacuum before use. In a general procedure, water and methanol can be flushed with nitrogen. L-ascorbyl 4-hydroxyphenyl acetate (7) can be added to the reaction mixture. Horseradish peroxidase can be dissolved in 200 μL of water. Hydrogen peroxide and 2,4-pentanedione can be simultaneously after the addition of the enzyme. Polymerization can be conducted for 24 h with continuous stirring. The reaction mixture can be poured into methanol. The excess methanol can be evaporated and the crude product can be washed with acetone to remove the unpolymerized monomer. The product, polymerized L-ascorbyl 4-hydroxyphenyl acetate (7), can be dried under vacuum.

### Example 6

### Enzymatic Polymerization of Retinol and Tocol Functionalized Monomers.

The following Example illustrates that the methods of this invention can be used to enzymatically polymerize a variety of antoxidants, such as retinol (Vitamin A) and tocol (Vitamin E), which have been coupled to monomers.

(i) Enzymatic Polymerization of Retinol Coupled Vinyl Monomers: Synthesis of Polymerized Retinyl 4-Vinylbenzoate (11)

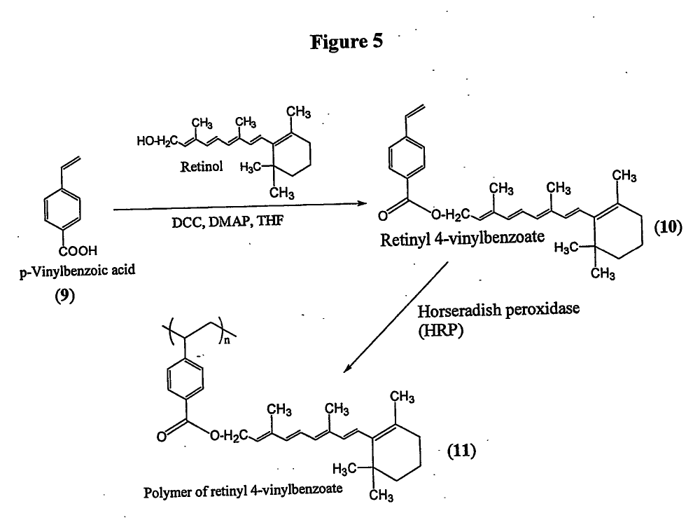

As illustrated in FIG. 5, retinyl 4-vinylbenzoate (10) was synthesized from p-vinylbenzoic acid (9) (310 mg, 2.09 mM), retinol (500 mg, 1.75 MM), 4-(dimethylamino)pyridine (320 mg, 2.62 mM) and 1,3-dicyclohexylcarbodiimide (DCC, 540 mg, 2.62 mM). The substrates was stirred in 50 mL tetrahydrofuran at 25° C. for 24 hours. 50 mg of 2,6-di-tert-butyl-4-methylphenol was added to the reaction mixture to avoid vinyl polymerization during solvent evaporation. The reaction was monitored by silica gel thin layer chromatography. Crude product was purified using silica gel column chromatography. The product, retinyl 4-vinylbenzoate (10), can be analyzed by NMR. In addition, known methods of hydroxyl coupling with acid groups can be used to produce retinyl 4-vinylbenzoate (10), such as the synthesis methods described in Zhao et al. J. Org. Chem. 2000, 65, 2933-2938; Langer et al. Macromolecules 1999, 32, 3658-3662; and Calmes et al. Tetrahedron Asymmetry 2000, 11, 737-741.

Retinyl 4-vinylbenzoate (10) can be polymerized to form (11) using enzyme horseradish peroxidase, oxidant hydrogen peroxide and initiator 2,4-pentanedione using the protocol described above in Example 3.

(ii) Enzymatic Polymerization of Retinol Coupled Phenolic Monomers: Synthesis of Polymerized Retinyl 4-Hydroxybenzylacetate (15)

As illustrated in Example 6, retinyl 4-hydroxybenzylacetate (14) can be synthesized from 4 hydroxyphenylacetic acid (265 mg, 1.75 mM), retinol (500 mg, 1.75 mM), 4-(dimethylamino)pyridine (255 mg, 2.09 mM) and 1,3-dicyclohexylcarbodiimide (DCC, 432 mg, 2.09 mM). The reaction can be stirred in 50 mL tetrahydrofuran at 25° C. for 24 hours and monitored by silica gel thin layer chromatography. The crude product can be purified using silica gel column chromatography. In addition, known methods of hydroxyl coupling with acid groups can be used to produce retinyl 4-hydroxybenzylacetate (14), such as the synthesis methods described in Zhao et al. J. Org. Chem. 2000, 65, 2933-2938; Langer et al. Macromolecules 1999, 32, 3658-3662; and Calmes et al. Tetrahedron Asymmetry 2000, 11, 737-741.

Retinyl 4-hydroxybenzylacetate (14) can be polymerized to form (15) using enzyme horseradish peroxidase and oxidant hydrogen peroxide using the protocols described in Example 5(iii).

(iii) Enzymatic Polymerization of Tocol Coupled Vinyl Monomers: Synthesis of Polymerized 2-Methyl-2-(4,8,12-trimethyltridecyl)-6-(4-vinylbenzoyl)-chromanol (20)

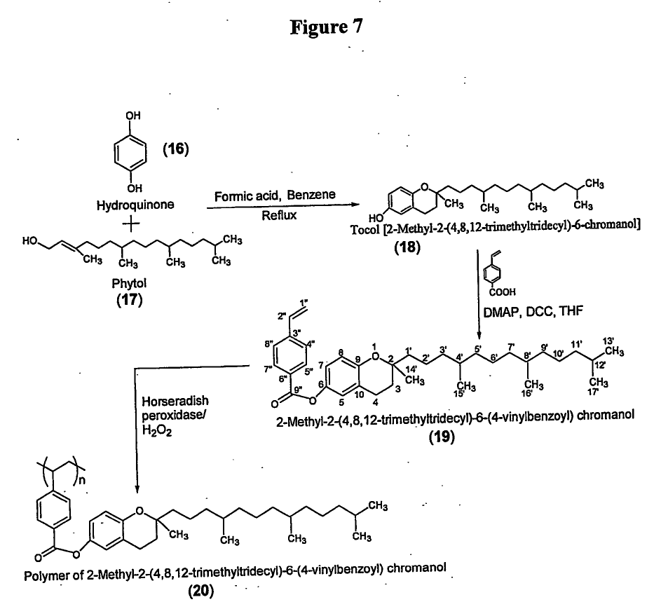

The steps of this Example are illustrated in FIG. 7. The first step is the production of tocol [2-Methyl-2-(4,8,12-trimethyltridecyl)-6-chromanol] (18). Tocol [2-Methyl-2-(4,8,12-trimethyltridecyl)-6-chromanol] (18) was produced using hydroquinone (16) (4.4 g, 39.86 mmol), phytol (17) (11.8 g, 39.79 mmol), formic acid (60 mL) and dry benzene (60 mL) refluxed under nitrogen atmosphere for five hours. The benzene layer was separated using separating funnel. The acid layer was extracted five times with (5×50 mL) benzene and the combined benzene solution was dried over sodium sulfate (anhydrous) and vacuum distilled. Removal of solvent left a light brown oil. The crude product gave a mixture of five compounds (by silica-gel thin layer chromatography) which was purified by silica-gel column chromatography using eluent chloroform:petroleum ether in 30:70 ratio. The purified compound, tocol [2-Methyl-2-(4,8,12-trimethyltridecyl)-6-chromanol] (18), was characterized by ¹H and ¹³C NMR. ¹H NMR (CDCl₃): δ 0.85 (12H, m, C-13′, C-15′, C-16′, & C-17′), δ 1.0-1.90 (14H, 4m, C-3H, C-2′H to C-12′H & C-14′H), δ 2.70 (2H, t, C-4H), δ 6.70 (3H, m, C-5H, C-7H & C-8H). ¹³C NMR (CDCl₃): δ 19.86, 19.93, 21.28, 22.48, 22.82, 22.92, 24.25, 24.63, 24.98 (C-2′, C-6′, C-10′, C-13′, C-14′, C-15′, C-16′, C-17′), δ 28.14, 32.86, 32.87, 32.94, 37.44, 37.56, 39.53 (C-1′, C-3′, C-4′, C-5′, C-7′, C-8′, C-9′, C-11′, C-12′), δ 76.27(C-2), 114.76 (C-5), 115.72 (C-7), 117.94 (C-8), 122.19 (C-10), 147.76, 148.71 (C-6 & C-9).

The second step is functionalizing the vinyl monomers with the antioxidant tocol (18) to form 2-methyl-2-(4,8,12-trimethyltridecyl)-6-(4-vinylbenzoyl)-chromanol (19). p-Vinylbenzoic acid (763 mg, 5.15 mM), tocol (1.8 g, 4.64 mM), 4-(dimethylamino)pyridine (940 mg, 7.7 mM) and 1,3-dicyclohexylcarbodiimide (DCC, 1.594 g, 7.7 mM) were stirred in 50 mL tetrahydrofuran at 25° C. for 24 hours. 50 mg of 2,6-di-tert-butyl-4-methylphenol was added to the reaction mixture to avoid vinyl polymerization during solvent evaporation. The reaction was monitored by silica gel thin layer chromatography. The crude product was purified using silica gel column chromatography with eluent consisting of chloroform:petroleum ether in 30: 70 ratio. The product, 2-methyl-2-(4,8,12-trimethyltridecyl)-6-(4-vinylbenzoyl)-chromanol (19), was isolated in 78% yield. ¹H NMR (CDCl₃): δ 0.85 (12H, m, C-13′, C-15′, C-16′, & C-17′), δ 1.0-1.90 (14H, 4m, C-1′H to C-12′H & C-14′H), δ 2.70 (2H, t, C-4H), δ 5.40 (1H, d, C-1″H), δ 5.89 (1H d, C-2″H), δ 6.80 (4H, m, C-1″H, C-5H, C-7H & C-8H), δ 7.50 (2H, d, C-4″H & C-8″H), δ 8.13 (2H, d, C-5″H & C-7″H). ¹³C NMR (CDCl₃): δ 19.83, 19.90, 19.97, 21.26, 22.26, 22.54, 22.93, 24.42, 24.67, 25.01(C-2′, C-6′, C-10′, C-13′, C-14′, C-15′, C-16′, C-17′), δ 28.18, 30.83, 32.93, 32.98, 37.50, 37.60, 37.65, 37.76, 39.59, 40.19, 40.24 (C-1′, C-3′, C-4′, C-5′, C-7′, C-8′, C-9′, C-11′, C-12′), 76.67 (C-2), 116.97 (C-1″), 118.05, 120.56, 122.11 (C-5, C-7, & C-8), 126.43 (C-4″ & C-8″), 129.13 (C-10), 130.62 (C-5″0 & C-7″), 136.20 (C-2″), 142.62, 143.61 (C-9, C-6″), 151.98 (C-6), 165.60 (C-9″).

The compound 2-methyl-2-(4,8,12-trimethyltridecyl)-6-(4-vinylbenzoyl)-chromanol can be polymerized to form (20) using enzyme horseradish peroxidase in the presence of hydrogen peroxide and 2,4-pentanedione using the protocols in Example 5 (iii).

What is claimed is:

1-118. (canceled)

119. A method for enzymatically synthesizing a functionalized polymer comprising:
coupling an antioxidant to each of a plurality of monomers; and,
enzymatically polymerizing the antioxidant-coupled monomers to form an antioxidant-coupled functionalized polymer;
whereby the resultant functionalized polymer has inherent antioxidant capabilities.

120. The method of claim 119, wherein the step of coupling an antioxidant to each of a plurality of monomers is carried out such that the resultant polymer has at least 1% of its monomeric units functionalized with antioxidants.

121. The method of claim 119, wherein the step of coupling an antioxidant to each of a plurality of monomers is carried out such that the resultant polymer has at least 10% of its monomeric units functionalized with antioxidants.

122. The method of claim 119, wherein the method further comprises coupling at least one antioxidant per monomer.

123. The method of claim 119, wherein the method further comprises selecting a monomer from the group consisting of vinylbenzoic acid, amino acids, amino acid derivatives, carbohydrates, lactones, lactides, cyclic carbonates, esters, olefins, amides, urethanes, acrylides, vinyl monomers, vinyl ethers, acetals, aryl sulfones, ether sulfones, imides, etherketones, phenylene oxides, phenylene sulfides, carbonates, epoxides, phenolics, aminoplasts, sophorolactones, nucleosides, and dendrimers.

124. The method of claim 119, wherein the step of coupling an antioxidant to each of a plurality of monomers further comprises using an enzyme.

125. The method of claim 124, wherein the step of coupling an antioxidant to each of a plurality of monomers further comprises selectively acylating primary hydroxyl groups.

126. The method of claim 124, wherein the method further comprises enzymatically coupling a primary hydroxyl group of the antioxidant to the monomer.

127. The method of claim 124, wherein the step of enzymatically coupling an antioxidant to each of a plurality of monomers further comprises selecting an enzyme from the group consisting of proteases, glycosidases, and lipases.

128. The method of claim 124, wherein the method further comprises utilizing Candida antarctica lipase.

129. The method of claim 119, wherein the method further comprises selecting the antioxidant from the group consisting of ascorbic acids, vitamin E derivatives, tocols, α-tocopherols, β-tocopherols, γ-tocopherols, φ-tocopherols, ε-tocopherols, ξ1-tocopherols, ξ2-tocopherols, η-tocopherols, vitamin B derivatives, thiamines, cyanocobalamins, ergocalciferols, cholecalciferols, vitamin K derivatives, phytonadiones, menaquinones, quercetins, vitamin A derivatives, retinols, retinals, 3,4-didehydroretinols, α-carotenes, β-carotenes, δ-carotenes, γ-carotenes, cryptoxanthins, citric acid, butylated hydroxyanisoles, butylated hydroxytoluenes, alpha-lipoic acids, glutathiones, carotenoids, allylic sulfides, selegilines, N-actylcysteines, lecithins, tartaric acids, caffeic acids, diaryl amines, thioethers, quinones, tannins, xanthenes, procyanidins, porphrins, phenolphthaleins, indophenol, coumarins, flavones, flavanones, and isomers, derivatives, and combinations thereof.

130. The method of claim 119, wherein the step of coupling an antioxidant to each of a plurality of monomers further comprises coupling ascorbic acid to the monomers.

131. The method of claim 119, wherein the method of enzymatically polymerizing the antioxidant-coupled monomers further comprises using horseradish peroxidase (HRP).

132. The method of claim 119, wherein the method further comprises casting the polymer into a shaped form.

133. The method of claim 132, wherein the form is selected from the group consisting of films, fibers, coatings, sheets, tubes and combinations thereof.

134. The method of claim 119, wherein the method further comprises selecting a monomer that is biodegradable.

135. The method of claim 119, wherein the method further comprises selecting biodegradable monomers from the group consisting of polyesters, glycolides, lactides, trimethylene carbonates, caprolactones, dioxanone, hydroxybutyrates, hydroxyvalerates, carbonates, amino acids, “pseudo” amino acids, esteramides, anhydrides, orthoesters, sophorolactones, nucleosides, dendrimers, and combinations thereof.

136. The method of claim 119, wherein the method further comprises selecting a single type of monomer and the step of polymerizing the antioxidant-coupled monomers into an antioxidant-coupled polymer further comprises forming an antioxidant-coupled homopolymer.

137. The method of claim 119, wherein the method further comprises selecting a plurality of different monomers and the step of polymerizing the antioxidant-coupled monomers into an antioxidant-coupled polymer further comprises forming an antioxidant-coupled copolymer.

138. A method of protecting an oxygen sensitive material from degradation comprising:
coupling an antioxidant to each of a plurality of monomers;
enzymatically polymerizing the antioxidant-coupled monomers to form an antioxidant-coupled polymer; and,
surrounding the material within the antioxidant-coupled polymer,
whereby the antioxidant-coupled polymer scavenges free radicals so as to protect material from oxygen degradation.

139. The method of claim 138, wherein the step of coupling an antioxidant to each of a plurality of monomers further comprises using an enzyme.

140. The method of claim 138, wherein the method further comprises selectively acylating a primary hydroxyl group of the antioxidant.

141. The method of claim 138, wherein the method further comprises housing oxygen sensitive material in direct contact with the shaped form.

142. The method of claim 138, wherein the method further comprises forming a packaging for foodstuff, wherein the antioxidant coupled polymer is in direct contact with the foodstuff.

143. The method of claim 138, wherein the method further comprises coating a pharmaceutical agent with the antioxidant coupled polymer.

144. The method of claim 138, wherein the method further comprises applying a second oxygen impermeable packaging material coating the antioxidant coupled polymer, distal to the oxygen sensitive material.

145. The method of claim 138, wherein the method further comprises utilizing biodegradable monomers.

146. The method of claim 138, wherein the method further comprises implanting the antioxidant-coupled polymer into a subject.

147. A medical device having at least one surface coated with a polymer comprising monomeric units functionalized with antioxidants, the polymer formed by coupling the antioxidants to each of a plurality of monomeric units to form antioxidant-coupled monomeric units and enzymatically polymerizing the antioxidant-coupled monomeric units,
whereby the polymer coated medical device scavenges free radicals so as to protect oxygen sensitive materials from oxygen degradation.

148. The medical device of claim 147, wherein the medical device is an implantable medical device selected from the group consisting of dialysis apparatus, stents, filtration apparatus, catheters, sutures, tubings, syringes, endoscopes, and prostheses.

149. The medical device of claim 147, wherein the antioxidant functionalized polymer coats a medical device, such that the antioxidant-coupled polymer is in direct contact with oxygen sensitive materials.

150. The medical device of claim 147, wherein a second oxygen impermeable material coats the antioxidant-coupled polymer, distal to the oxygen sensitive material.

151. The medical device of claim 147, wherein the monomeric units are biodegradable monomers.

152. The medical device of claim 147, wherein at least 1% of its monomeric units are functionalized with antioxidants.

153. An antioxidant coupled packaging material comprising,
a first film layer cast from a polymer with monomeric units functionalized with an antioxidant, the polymer formed by coupling the antioxidant to each of a plurality of monomeric units to form antioxidant-coupled monomeric units and enzymatically polymerizing the antioxidant-coupled monomeric units; and,
a second barrier film layer,
such that the first layer encases a material and the second layer is oxygen impermeable.

154. A controlled delivery system for antioxidants comprising
an antioxidant bound to a biodegradable polymer composed of biodegradable monomers, the biodegradable polymer formed by coupling the antioxidant to each of a plurality of biodegradable monomers to form antioxidant-coupled biodegradable monomers and enzymatically polymerizing the antioxidant-coupled biodegradable monomers, wherein the antioxidant is present in an amount from about 20% to about 80% (w/w).

155. The controlled delivery system of claim 154, wherein the antioxidant-coupled polymer comprises a topical ointment.

156. A method of controlled delivery of an antioxidant to a subject comprising
coupling an antioxidant to each of a plurality of biodegradable monomers; and
enzymatically polymerizing the antioxidant-coupled biodegradable monomers;
whereby the resultant antioxidant coupled polymer will degrade over time and deliver the antioxidant at a controlled rate to a subject.

157. The method of claim 156, wherein the method further comprises coupling at least 70% of the resultant polymer's monomer units with antioxidants.

158. The method of claim 156, wherein the step of coupling an antioxidant to each of a plurality of biodegradable monomers further comprises utilizing an enzyme.

159. The method of claim 158, wherein the method further comprises selectively acylating a primary hydroxyl group of the antioxidant.

160. The method of claim 158, wherein the step of enzymatically coupling an antioxidant to each of a plurality of monomers further comprises utilizing a lipase.

161. The method of claim 156, wherein the step of polymerizing the antioxidant-coupled monomers further comprises using the enzyme horseradish peroxidase (HRP).

162. The method of claim 156, wherein the method further comprises casting the antioxidant-coupled polymer into a shaped form selected from the group consisting of a film, a fiber, a coating, a sheet, and combinations thereof.

163. The method of claim 162, wherein the method further comprises housing oxygen sensitive material in direct contact with the shaped form.

164. The method of claim 156, wherein the method further comprises coating a pharmaceutical agent with the antioxidant-coupled biodegradable polymer.

165. The method of claim 156, wherein the method further comprises embedding a pharmaceutical agent within the antioxidant-coupled biodegradable polymer.

166. An ascorbyl coupled polymer with inherent antioxidant activity comprising functionalized units of formula: 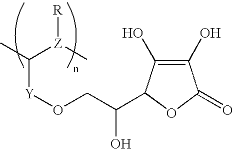
wherein Y is absent, C₂H₂O, C₇H₄O or a linking group;
Z is selected from the group consisting of O, S, N, C, CH, C₆H₃, C₆H₄, CₐH_{b}, C₆H₁₀O₂, and CₐH_{b}Oₘ, wherein a, b, and m are integers;
R is selected from the group consisting of absent, hydrogen, oxygen, an alkyl, a hydroxy, an aryl, an aliphatic group, an aromatic group, an acyl group, an alkoxy group, an alkylene group, an alkenylene group, an alkynylene group, a hydroxycarbonylalkyl group, an anhydride, a halide, an amide, an amine, and a heterocyclic aromatic group; and
n is an integer greater than or equal to one, denoting the degree of polymerization.

167. The ascorbyl coupled polymer of claim 166, wherein at least 1% of the polymer comprises the functionalized units.

168. The ascorbyl coupled polymer of claim 166, wherein at least 10% of the polymer comprises the functionalized units.

169. The ascorbyl coupled polymer of claim 166, wherein at least 50% of the polymer comprises the functionalized units.
